(19) United States
(12) Patent Application Publication
(10) Pub. No.: US 2025/0030837 A1
(43) Pub. Date: Jan. 23, 2025

(54) METHOD AND APPARATUS FOR VIDEO CODING USING SELECTIVE MULTIPLE REFERENCE LINE

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Byeung Woo Jeon, Seongnam-si (KR); Jee Yoon Park, Seoul (KR); Yu Jin Lee, Suwon-si (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/903,424

(22) Filed: Oct. 1, 2024

Related U.S. Application Data
(63) Continuation of application No. PCT/KR2023/003367, filed on Mar. 13, 2023.

(30) Foreign Application Priority Data
Apr. 5, 2022 (KR) 10-2022-0042016
Sep. 2, 2022 (KR) 10-2022-0111486
Mar. 9, 2023 (KR) 10-2023-0031219

(51) Int. Cl. H04N 19/105; H04N 19/159; H04N 19/174

(52) U.S. Cl. CPC H04N 19/105; H04N 19/159; H04N 19/174

(57) ABSTRACT

A video decoding device decodes from a bitstream an intra-prediction mode of the current block, derives a reference line group of the current block, and derives a reference line from within the reference line group. Further, the video decoding device generates a predictor of the current block by using the reference line according to the intra-prediction mode.

### CROSS REFERENCE TO RELATED APPLICATIONS

This application is a continuation of International Application No. PCT/KR2023/003367 filed on Mar. 13, 2023, which claims priority to and the benefit of Korean Patent Application No. 10-2022-0042016 filed on Apr. 5, 2022, Korean Patent Application No. 10-2022-0111486 filed on Sep. 2, 2022, and Korean Patent Application No. 10-2023-0031219, filed on Mar. 9, 2023, the entire contents of each of which are incorporated herein by reference.

### TECHNICAL FIELD

The present disclosure relates to a video coding method and an apparatus using selective multiple reference lines.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra-prediction utilizes pixel information within the same picture to predict pixel values of the current block to be encoded. In intra-prediction, among multiple intra-prediction modes, one mode may be selected that best fits the features of the picture and used to predict the current block. The encoder selects and then uses one of the multiple intra-prediction modes to encode the current block. The encoder may then pass information on that mode to the decoder.

HEVC technology utilizes a total of 35 intra-prediction modes for intra-prediction, including 33 angular modes that have directionality and two non-angular modes that have no directionality. However, as the spatial resolution of videos increases from 720×480 to 2048×1024 or 8192×4096, the unit size of the prediction block becomes larger and larger, and it is necessary to add more diverse intra-prediction modes. As illustrated in FIG. 3A, the VVC technique utilizes 67 more subdivided prediction modes for intra-prediction, allowing for a greater variety of prediction directions than in the prior art.

Since in intra prediction, the predictor is generated based on the neighboring pixels of the current block, the performance of the intra prediction technique is related to the proper selection of reference pixels. In this regard, in addition to obtaining reference pixels from more accurate angular directions by diversifying the prediction modes as described above, one can consider increasing the number of available candidate reference pixels. Prior art techniques for the latter include Multiple Reference Line (MRL) or Multiple Reference Line Prediction (MRLP). The MRL technique not only uses reference lines adjacent to the current block for prediction of the current block but can also use pixels further away as reference pixels. However, MRL needs to perpetually take into account multiple candidate reference lines, which is the issue to be resolved. Therefore, there is a need to provide methods for efficiently utilizing reference lines to increase video encoding efficiency and enhance video quality.

### SUMMARY

The present disclosure seeks to provide a video coding method and an apparatus for selectively determining available reference lines in intra predicting the current block, based on a reference line group including some of multiple reference lines.

Additionally, the present disclosure seeks to provide a video coding method and an apparatus that utilize a new reference line generated by the weighted combining of multiple reference lines.

Additionally, the present disclosure seeks to provide a video coding method and an apparatus for controlling the available reference lines among the multiple reference lines.

At least one aspect of the present disclosure provides a method performed by a video decoding device for intra-predicting a current block. The method includes decoding, from a bitstream, an intra-prediction mode of the current block. The method also includes deriving a reference line group of the current block, and the reference line group comprises at least one reference line. The method also includes deriving a reference line within the reference line group. Here, the reference line in the reference line group is indicated by a reference line candidate index. The method also includes and generating a predictor of the current block by using the reference line according to the intra-prediction mode.

Another aspect of the present disclosure provides a method performed by a video encoding device for intra-predicting a current block. The method includes determining an intra-prediction mode of the current block. The method also includes deriving a reference line group of the current block, and the reference line group comprises at least one reference line. The method also includes deriving a reference line within the reference line group. Here, the reference line in the reference line group is indicated by a reference line candidate index. The method also includes generating a predictor of the current block by using the reference line according to the intra-prediction mode.

Yet another aspect of the present disclosure provides a computer-readable recording medium storing a bitstream generated by a video encoding method. The video encoding method includes determining an intra-prediction mode of a current block. The video encoding method also includes deriving a reference line group of the current block, and the reference line group comprises at least one reference line. The video encoding method also includes deriving a reference line within the reference line group. Here, the reference line in the reference line group is indicated by a reference line candidate index. The video encoding method also includes generating a predictor of the current block by using the reference line according to the intra-prediction mode.

As described above, the present disclosure provides a video coding method and an apparatus that selectively determine available reference lines in the intra prediction of the current block, based on a reference line group including some of the multiple reference lines. Thus, the video coding method and the apparatus increase video coding efficiency and enhance video quality.

Furthermore, the present disclosure provides a video coding method and an apparatus that utilize a new reference line generated by the weighted combining of the multiple reference lines. Thus, the video coding method and the apparatus increase video coding efficiency and enhance video quality.

Furthermore, the present disclosure provides a video coding method and an apparatus that control the available reference lines among the multiple reference lines. Thus, the video coding method and the apparatus increase video coding efficiency and enhance video quality.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the reference lines indicated by a reference line index.

FIG. 7 is a diagram illustrating a search order for reference samples.

FIGS. 8A and 8B are diagrams illustrating the generation of reference samples.

FIG. 9 is a diagram illustrating a graph of the percentage of reference lines utilized by block size.

FIGS. 10A and 10B are diagrams illustrating the inference of a reference line group, according to at least one embodiment of the present disclosure.

FIG. 11 is a diagram illustrating a weighted combination of two reference lines, according to at least one embodiment of the present disclosure.

FIG. 12 is a diagram illustrating block types based on block positions in a video, according to at least one embodiment of the present disclosure.

FIG. 13 is a diagram illustrating the location of pixels to define adjacent blocks, according to at least one embodiment of the present disclosure.

FIG. 14 is a diagram illustrating a plurality of adjacent blocks on the top and left, according to at least one embodiment of the present disclosure.

FIG. 15 is a diagram illustrating pixels defining adjacent blocks, according to at least one embodiment of the present disclosure.

FIG. 16 is a diagram illustrating reference lines indicated by reference line indices based on block areas, according to at least one embodiment of the present disclosure.

FIG. 17 is a flowchart of a method performed by a video encoding device for encoding the current block, according to at least one embodiment of the present disclosure.

FIG. 18 is a flowchart of a method performed by a video decoding device for decoding the current block, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

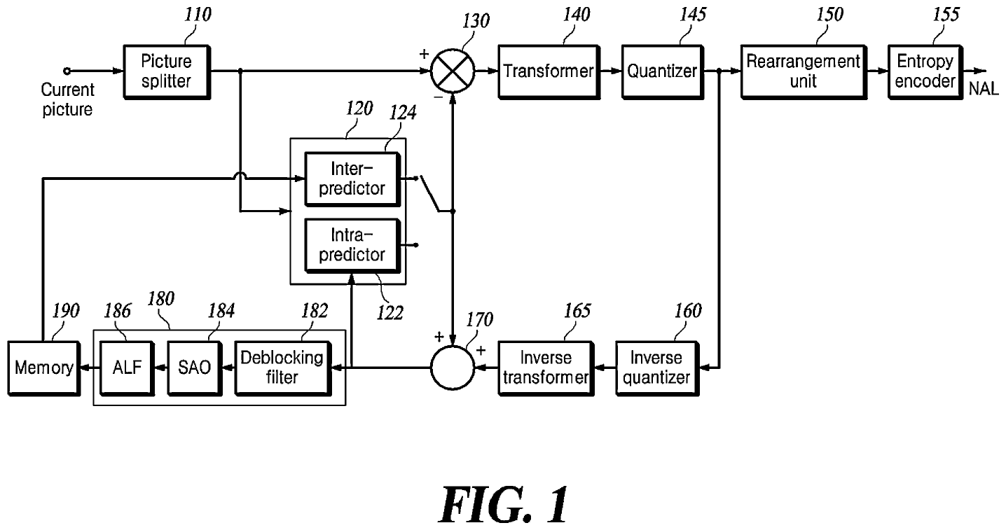

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

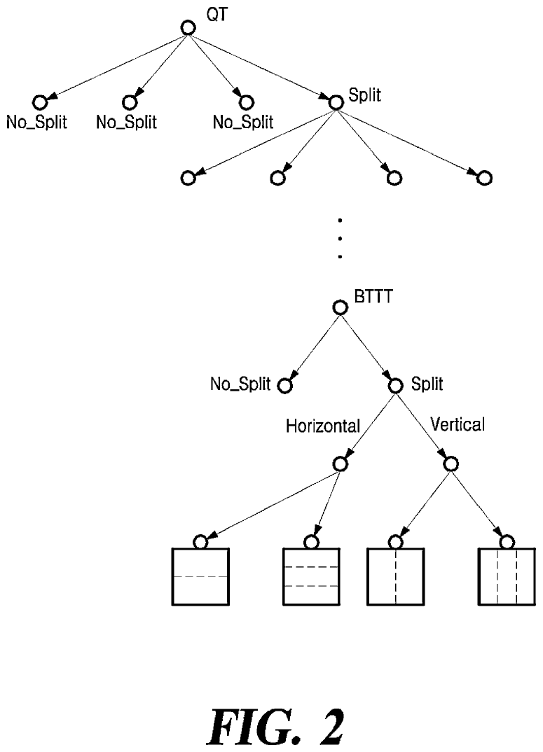

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

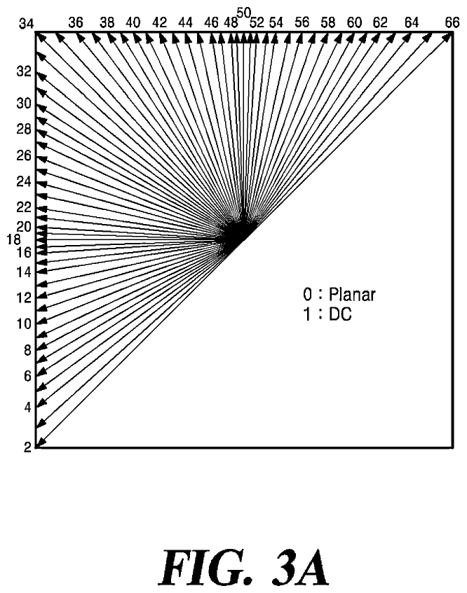

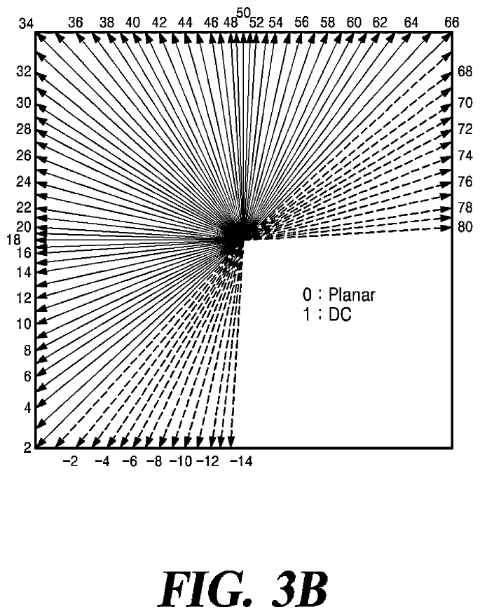

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

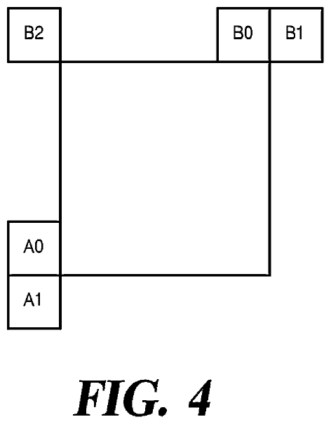

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

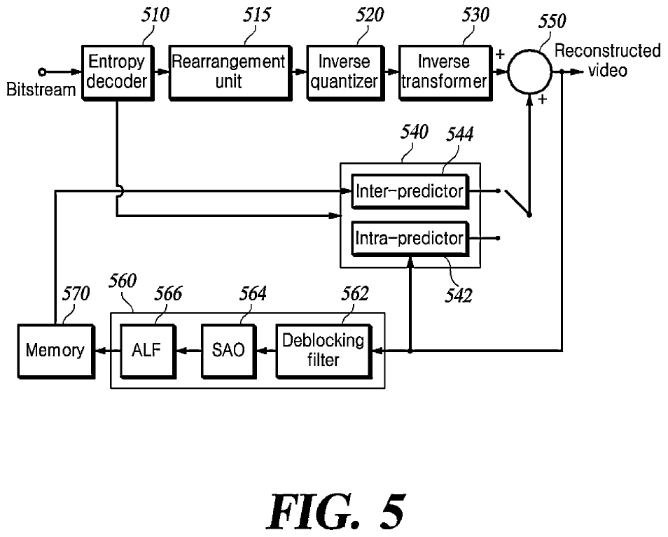

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that selectively determine available reference lines in the intra prediction of the current block, based on a reference line group including some of the multiple reference lines. Furthermore, the present disclosure provides a video coding method and an apparatus that utilize a new reference line generated by the weighted combining of the multiple reference lines. Furthermore, the present disclosure provides a video coding method and an apparatus that control the available reference lines among the multiple reference lines.

The following embodiments may be performed by the intra predictor 122 in the video encoding device. The following embodiments may also be performed by the intra predictor 542 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

Hereinafter, embodiments are described centered about the video decoding device, but the embodiments may be likewise applied to the video encoding device.

### I. MPM and MRL

Several techniques are introduced to improve encoding efficiency by using intra-prediction. The most probable mode (MPM) technique utilizes the intra-prediction mode of neighboring blocks for intra prediction of the current block. The video decoding device generates an MPM list to include intra-prediction modes derived from predefined locations that are spatially adjacent to the current block. When MPM mode is applied, the video encoding device may send a flag, intra_luma_mpm_flag, to the video decoding device indicating whether the MPM list is to be used. If intra_luma_mpm_flag is not present, intra_luma_mpm_flag is inferred to be 1. Further, the video encoding device may transmit the MPM index, intra_luma_mpm_idx, instead of the index of the prediction mode, thereby increasing the coding efficiency of the intra-prediction mode.

The multiple reference line (MRL) technology, when the current block is predicted according to the intra-prediction technology, may use not only the reference lines adjacent to the current block but also the pixels that exist further away as reference pixels. In this case, pixels with the same distance from the current block are grouped and called a reference line. The MRL technique uses pixels located on the selected reference line to perform intra prediction of the current block.

The video encoding device, for indicating the reference line to be used when the intra prediction is performed, signals a reference line index (hereinafter used interchangeably with ‘intra_luma_ref_idx’) to the video decoding device. The bit allocation for each index may be shown in Table 1.

TABLE 1

| intra_luma_ref_idx | Bit allocation |
|---|---|
| 0 | 0 |
| 1 | 10 |
| 2 | 11 |

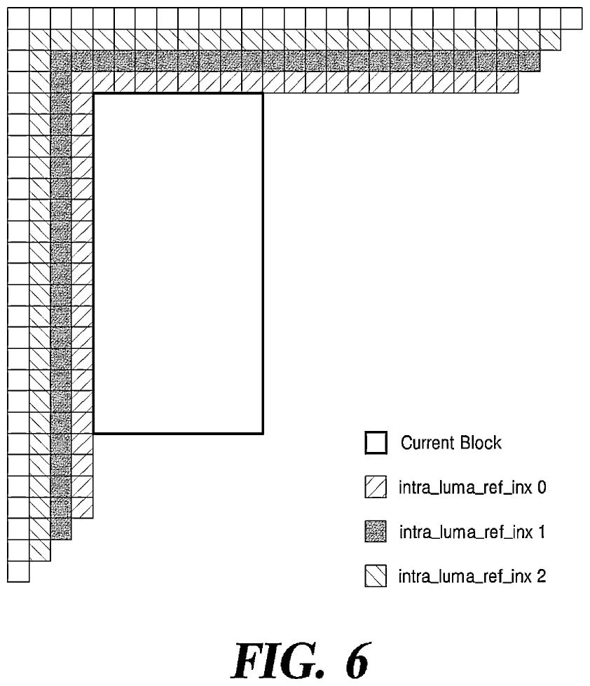

The video decoding device may consider whether to use additional reference lines by applying the MRL for the intra-prediction modes that are signaled according to the MPM, except for planar. The reference line represented by each intra_luma_ref_idx is shown in the example of FIG. 6. In the VVC (Versatile Video Coding) technique, the video decoding device selects one of the three reference lines that are closer in distance to the current block for use in the intra prediction of the current block. The syntax associated with signaling the reference line index of intra_luma_ref_idx used for prediction and the prediction mode of the current block is shown in Table 2.

```
TABLE 2
} else {
  if( sps_mrl_enabled_flag && ( ( y0 % CtbSizeY ) > 0 ) )
    intra_luma_ref_idx
  if( sps_isp_enabled_flag && intra_luma_ref_idx = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( intra_luma_ref_idx = = 0 )
    intra_luma_mpm_flag[ x0 ][ y0 ]
  if( intra_luma_mpm_flag[ x0 ][ y0 ] ) {
    if( intra_luma_ref_idx = = 0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

First, the video decoding device parses intra_luma_ref_idx to determine the reference line index to use for prediction. Since the Intra Sub-Partitions (ISP) technique is applicable when the reference line index is zero, the video decoding device does not parse information related to ISP when the reference line index is non-zero.

The MRL technique and MPM mode may be combined as follows.

First, if intra_luma_ref_idx is 0, a flag, intra_luma_not_planar_flag, indicating whether the planar mode is to be used, may be signaled from the video encoding device to the video decoding device. If intra_luma_not_planar_flag is false, intra-prediction mode is set to planar mode, and if intra_luma_not_planar_flag is true, intra_luma_mpm_idx may be additionally signaled. If intra_luma_not_planar_flag is not present, intra_luma_not_planar_flag may be inferred to be 1.

Next, if intra_luma_ref_idx is non-zero, the planar mode is not used. Therefore, intra_luma_not_planar_flag is not transmitted and is assumed to be true. Since intra_luma_not_planar_flag is true, intra_luma_mpm_idx may be additionally signaled.

As described above, the intra prediction generates a predictor by referencing neighboring pixels of the current block. The neighboring pixels to be referenced are referred to as reference samples. Before the intra prediction, the video decoding device prepares the reference samples. The video decoding device checks the availability of reference samples for the position of the pixel to be referenced. If the reference sample does not exist, the pixel value is filled in the position of the pixel to be referenced, according to a predetermined agreement between the video encoding device and the video decoding device. Then, the final reference samples may be generated by applying filters to the prepared reference samples.

In this case, the reference sample refUnfilt[x][y] before applying the filter may be generated as follows. In the following description, refIdx denotes the index of the reference line, refW and refH denote the width and height of the reference region, respectively.

If all samples in refUnfilt[x][y] are unavailable for intra prediction, all values of refUnfilt[x][y] are set to 1<<(BitDepth−1). Here, it is defined that x=−1−refIdx, y=−1−refIdx . . . refH−1, and x=−refIdx . . . refW−1, y=−1−refIdx.

On the other hand, if some refUnfilt[x][y] values are not available for intra prediction, the following method is applied.

If refUnfilt[−1−refIdx][refH−1] is not available, the available refUnfilt[x][y] is searched for by searching from ‘x=−1−refIdx, y=refH−1’ to ‘x=−1−refIdx, y=−1−refIdx’, and then from ‘x=−refIdx, y=−1−refIdx’ to ‘x=refW−1, y=−1−refIdx’. Upon terminating the search, refUnfilt[−1−refIdx][refH−1] is set to refUnfilt[x][y].

Further, if an unusable sample is present in the range of x=−1−refIdx, y=refH−2 . . . 1−refIdx, refUnfilt[x][y] is set to refUnfilt[x][y+1].

Additionally, if an unusable sample is present in the range of x=−refIdx . . . refW−1, y=−1−refIdx, refUnfilt[x][y] is set to refUnfilt[x−1] [y].

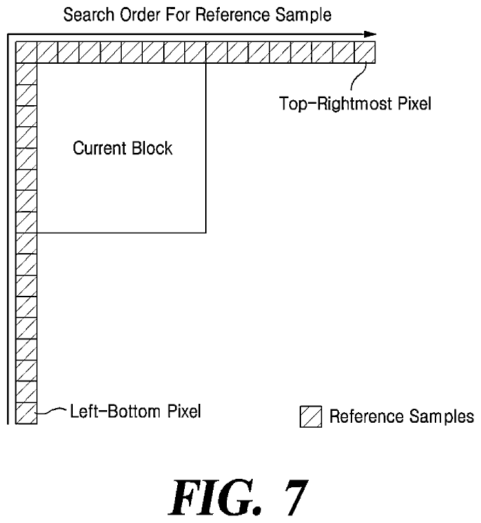

FIG. 7 is a diagram illustrating a search order for reference samples.

To determine whether the reference sample is available, the video decoding device searches clockwise from the bottom-left pixel to the top-rightmost pixel, as shown in the example of FIG. 7.

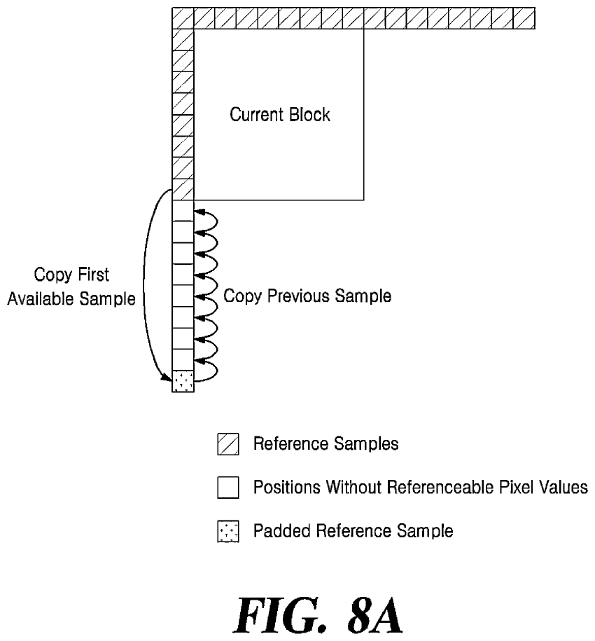

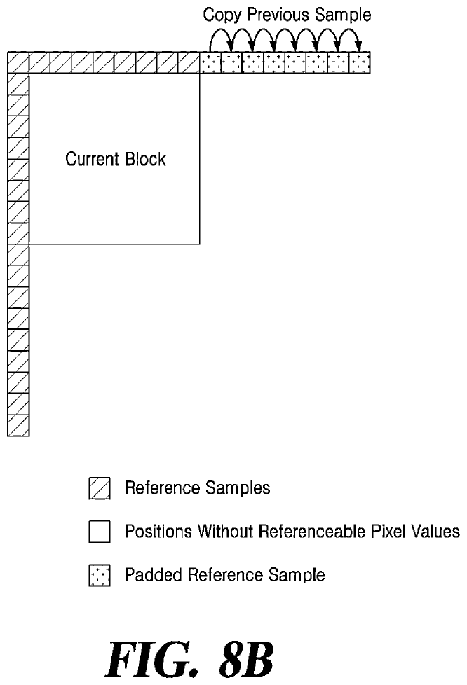

FIGS. 8A and 8B are diagrams illustrating the generation of reference samples.

If all reference pixels are available for use, the video decoding device does not perform padding and uses each reference pixel value. On the other hand, as described above, if some of the available reference samples are absent, the pixel values may be filled in, as illustrated in the examples of FIGS. 8A and 8B. First, if the bottom-left reference sample is unusable, the first available reference sample in the search order is copied and filled in the bottom-left reference sample, as shown in the example of FIG. 8A. Then, if no reference sample exists other than the bottom-left reference sample, the pixel value of the immediately preceding position in the search order is copied and filled in the current position, as shown in the example of FIGS. 8A and 8B.

As described above, if there are no reference samples available at all positions, the video decoding device fills each position with 2^{Bit-depth-1}, which is half of the maximum value that the pixel can have. For example, if the bit-depth is 8 bits, 128 may be utilized, and if the bit-depth is 10 bits, 512 may be utilized.

After generating the reference samples according to the method described above, the video decoding device may apply a filter to generate the final reference sample p[x][y]. First, the video decoding device may set filterFlag, a flag indicating the application of a filter, to 1 under the conditions that the reference line index of refIdx is 0, the size of the current block is greater than 32, the current block is a luma component, the IntraSubPartitionsSplitType of the ISP mode is ISP_NO_SPLIT, and refFilterFlag, a flag indicating the filtering of the reference samples, is 1. If any one of the above described conditions is not satisfied, filterFlag may be set to 0.

Then, if filterFlag is true, the final reference sample p[x][y] may be calculated as shown in Equation 1.

$$p [ - 1 ] [ - 1 ] = ( refUnfilt [ - 1 ] [ 0 ] + 2 \cdot refUnfilt [ - 1 ] [ - 1 ] + refUnfilt [ 0 ] [ - 1 ] + 2 ) >> 2 \qquad Equation l$$

$$p [ - 1 ] [ y ] = ( refUnfilt [ - 1 ] [ y + 1 ] + 2 \cdot refUnfilt [ - 1 ] [ y ] + refU nfilt [ - 1 ] [ y - 1 ] + 2 ) >> 2 , y = 0 .. refH - 2$$

$$p [ - 1 ] [ refH - 1 ] = refUnfilt [ - 1 ] [ refH - 1 ]$$

$$p [ x ] [ - 1 ] = ( refUnfilt [ x - 1 ] [ - 1 ] + 2 \cdot refUnfilt [ x ] [ - 1 ] + refU nfilt [ x + 1 ] [ - 1 ] + 2 ) >> 2 , x = 0 ¨ refW - 2$$

$$p [ refW - 1 ] [ - 1 ] = refU nfilt [ refW - 1 ] [ - 1 ]$$

On the other hand, if filterFlag is false, then for x=−1−refIdx, y=−1−refIdx . . . refH−1 and x=−refIdx . . . refW−1, setting that y=−1−refIdx, p[x][y]=refUnfilt[x][y] is performed.

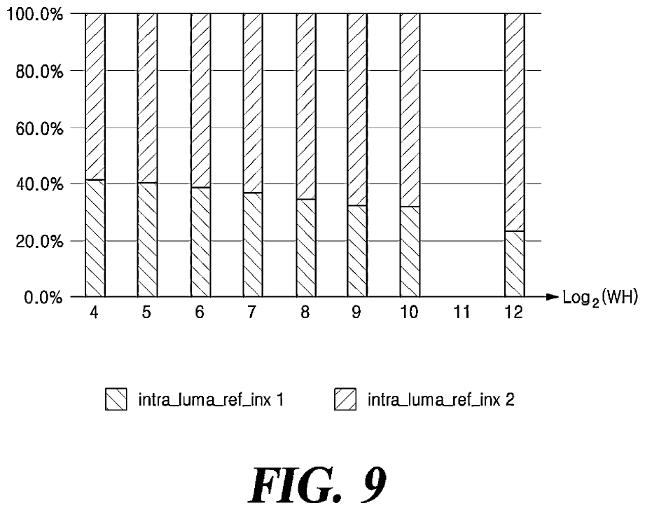

On the other hand, existing MRL techniques suffer from the disadvantage that the best reference line is always selected by comparing all candidate reference lines. The following are the inefficiencies that can occur when VVC's MRL technique is used, which is a conventional technique that considers 3 reference lines of intra_luma_ref_idx 0, intra_luma_ref_idx 1, intra_luma_ref_idx 2. For example, by calculating the proportion of reference lines used for each block size (log₂ WH) and normalizing the proportion with respect to intra_luma_ref_idx 1 and intra_luma_ref_idx 2, the proportion of blocks using both reference lines may be graphed as shown in the example in FIG. 9. From the example in FIG. 9, it may be seen that intra_luma_ref_idx 2, which is two pixels away from the current block, is used up to four times as much as intra_luma_ref_idx 1, which is one pixel away, as the block size increases. Therefore, failure to consider factors that affect the choice of reference lines, such as block size, as in conventional techniques, can lead to inefficiencies. With the increasing number of candidate reference lines that may be selected by MRL techniques, the inefficiency of traditional techniques that always consider all reference lines increases further, and the length of the bin allocated to each reference line can increase proportionally.

### II. Selective Multiple Reference Line (Selective MRL)

The present disclosure can solve these issues of the prior art by selectively determining which of multiple reference lines to use. To this end, a ‘reference line group’ is redefined by the present disclosure. A reference line group is a grouping of some of the N available reference lines (where N is a natural number). There may be K reference line groups (where K is a natural number greater than or equal to 1), each of which may contain the same number of candidate reference lines (m1=m2=m3, . . . ) or a different number of candidate reference lines. Here, m denotes the size of the reference line group, i.e., the number of reference lines included in the reference line group. If all N available reference lines are included in one reference line group, then K=1, and m=N. Hereinafter, for ease of explanation, the value of the index (intra_luma_ref_idx) of the N available reference lines may be expressed as 0 to N−1.

As an example, Table 3 shows the structures of three reference line groups.

TABLE 3

| | Reference Lines Included in Reference Line Group |
|---|---|
| Group 0 | {intra_luma_ref_idx 1, intra_luma_ref_idx 3} |
| Group 1 | {intra_luma_ref_idx 0, intra_luma_ref_idx 4, |
| | intra_luma_ref_idx 8} |
| Group 2 | {intra_luma_ref_idx 0} |

Here, “Group 0” includes two reference lines, “Group 1” includes three reference lines, and “Group 2” includes one reference line.

The reference line index indicates the reference line that is the index value's pixel distance away from the current block. Thus, an intra_luma_ref_idx 0 indicates a reference line that is contiguous (adjacent) to the current block, and an intra_luma_ref_idx 1 indicates a reference line that is one pixel away from the current block. Depending on the embodiment, a reference line index may indicate a reference line that is a pixel distance or a block distance away from the index value, both of which may indicate the position of the reference line.

To solve the above described issues, the present disclosure may determine a reference line for the prediction of the current block by selecting one of multiple reference line groups and selecting, combining, or limiting one of the reference lines included in the selected reference line group. When the current block is predicted by determining the reference line group used by the current block according to the predetermined method and selecting one of the reference lines included in the determined reference line group, the video decoding device, which is informed that one of the reference lines included in the determined reference line group is used for prediction, may parse the reference line candidate index (hereinafter, ‘ref_group_candidate_idx’) instead of intra luma_ref_idx indicating the reference line. Here, the first case may be for ref_group_candidate_idx to indicate which reference line is to be used within the determined reference line group, and a second case may be determining a reference line based on a predetermined mapping between ref_group_candidate_idx and intra_luma_ref_idx. In the second case, the video decoding device may perform the predetermined mapping for indicating m reference lines as included in the reference line group as ref_group_candidate_idx 0 to ref_group_candidate_idx m−1 by using an order of increasing value of the reference line index (intra_luma_ref_idx) in the reference line group, decreasing value of intra_luma_ref_idx in the reference line group, or any other relationship between the indices.

The following describes the first case. For example, if the reference line group is “Group 1” in Table 3, of which intra_luma_ref_idx 4 is used for prediction, the video decoding device determines which reference line is used by parsing ref_group_candidate_idx 1 for the current block. For convenience, the description assumes that the information on the reference lines is coded in a unary fashion and that N, which represents the number of available reference lines, is greater than 8, i.e., all three reference lines included in “Group 1” in Table 3 are available for use. First, if intra_luma_ref_idx is signaled, the codeword used is ‘11110’ because ‘4’ is coded. On the other hand, if the information on the reference line group is determined by inference and ref_group_candidate_idx is signaled, then the codeword used is ‘10’ because ‘1’ is Thus, if the information on the reference line group is signaled and coded. ref_group_candidate_idx is signaled, then “group 1−indicating codeword+10” may be used.

Using any m reference lines out of N reference lines, the reference line group may be organized in any way, such as {intra_luma_ref_idx i, intra_luma_ref_idx j, intra_luma_ref_idx k . . . }, and an example method is as follows. In this case, intra_luma_ref_idx 0 may be added regardless of the relationship with the other index values that establish geometric or arithmetic progression.

For example, the reference lines in a reference line group may be in an arithmetic progression. The reference line group may be configured such that the index values i, j, k, . . . of the reference lines, intra_luma_ref_idx i, intra_luma_ref_idx j, intra_luma_ref_idx k, . . . , included in the reference line group may be in an arithmetic progression. For example, when the common difference is 2, the reference line group may include intra_luma_ref_idx 0, intra_luma_ref_idx 2, intra_luma_ref_idx 4. Alternatively, when the common difference is 2, the reference line group may include intra_luma_ref_idx 1, intra_luma_ref_idx 3, intra_luma_ref_idx 5.

As another example, the reference lines in the reference line group may be in a geometric progression. The reference line group may be configured such that the index values i, j, k, . . . of the reference lines, intra_luma_ref_idx i, intra_luma_ref_idx j, intra_luma_ref_idx k, . . . , included in the reference line group are in a geometric progression. For example, when the common ratio is 3, the reference line group may include intra_luma_ref_idx 1, intra_luma_ref_idx 3, intra_luma_ref_idx 9.

Hereinafter, the above described approach to solve the issues with conventional MRL techniques is referred to as selective MRL. Some implementations of selective MRL are as follows.

To enable the application of each implementation (selective MRL), the video encoding device signals the sps_selective_mrl_enabled_flag or pps_selective_mrl_enabled_flag to the video decoding device at a higher level, such as the Sequence Parameter Set (SPS) or Picture Parameter Set (PPS). While the prior art MRL technology may refer to three reference lines, the present disclosure may have the video decoding device consider more than three reference lines, e.g., a natural number N of reference lines. Hereinafter, for convenience, the intra-prediction mode 18 in the horizontal direction is referred to as HOR_Idx and the intra-prediction mode 50 in the vertical direction is referred to as VER_Idx.

Implementation 1: Selecting reference line group and using one reference line thereof

In this implementation, to selectively utilize multiple reference lines, the video decoding device selects one of the K reference line groups and uses one of the reference lines included in the selected reference line group for prediction. In this implementation, (Implementation 1-1) the reference line group may be signaled or (Implementation 1-2) inferred by the video decoding device.

### Implementation 1-1: Signaling Reference Line Group

In this implementation, for selecting one of the multiple reference line groups, the video encoding device signals a reference line group index (hereinafter, ‘ref_group_idx’) indicative of a reference line group to the video decoding device. For example, as shown in Table 3, if three reference line groups exist and ‘Group 1’ is selected, ref_group_idx 1 is signaled.

Then, an index indicating which reference line to use for prediction among the reference lines included in the selected one reference line group, i.e., a reference line candidate index, may be (Implementation 1-1-1) signaled or (Implementation 1-1-2) inferred. The following describes the case where ref_group_candidate_idx indicates which reference line is to be used within the determined reference line group.

### Implementation 1-1-1: Signaling Reference Line Candidate Index

In this implementation, the video encoding device may signal a reference line candidate index (ref_group_candidate_idx) to indicate which reference line is to be used within the selected reference line group. According to Table 3, if ‘Group 1’ is selected and ref_group_candidate_idx 2 is signaled, intra_luma_ref_idx 8 is used for the prediction of the current block. If only one reference line exists within the selected reference line group, the video decoding device may still parse ref_group_candidate_idx, or may omit the parse and may infer ref_group_candidate_idx to be 0.

### Implementation 1-1-2: Inferring Reference Line Candidate Index

In this Implementation, when a ref_group_candidate_idx is inferred, the video decoding device may infer a ref_group_candidate_idx (i.e., a reference line) used according to a block feature or may use a reference line preset at a higher level such as SPS, PPS, and the like. Referenced here as the block feature may be at least one of the block width, height, area, aspect ratio and shape. These features are further detailed as follows, of which at least one may be referenced. Hereinafter, the distance between a block and a reference line may be an index value of the reference line, the number of pixels between the two, the number of blocks between the two, and the like.

First, referenced as current block's features may include the position, prediction mode, reference pixel, any predictors that can be generated, distance between the current block and the available reference line included in the selected reference line group, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

Referenced as features of an adjacent block of the current block may be such features as the position, the pixel value from the block reconstructed, prediction mode, reference line used for prediction, reference line group used, whether MRL is used, whether this implementation is used, information considered when this implementation is used, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, reference line group used, whether MRL is used, whether this implementation is used, information considered when this implementation is used, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and an adjacent block of the collocated block have features that may be referenced such as the position, the pixel value from the block reconstructed, prediction mode, reference line used for prediction, reference line group used, whether MRL is used, whether this implementation was used, information considered when this implementation is used, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

An example of inferring ref_group_candidate_idx based on the feature of the block to be referenced is as follows.

For example, if an area is referenced as a block feature, the larger the area of the block, the larger the reference line in its ref_group_candidate_idx, which is the value of the index in the selected reference line group, may be used for prediction. Alternatively, the reference line with a smaller index value may be used for prediction. Alternatively, when reference lines that are predetermined at a higher level, such as SPS, PPS, and the like are used, the video decoding device may use, for prediction, the reference line indicated by sps_ref_group_candidate_idx, pps_ref_group_candidate_idx, and the like from the reference line group selected respectively by all CUs or some CUs. For example, if sps_ref_group_candidate_idx is 1, the reference line with ref_group_candidate_idx 1 in the reference line group may always be used.

The syntax elements according to this implementation are as follows. At least one or more of these syntax elements may be used.

The selective MRL flag (hereinafter used interchangeably with ‘selective_mrl_flag’) is a flag that indicates whether selective MRL is applied, and may have values of 0 and 1. If this flag is 0, intra_luma_ref_idx 0 is used for prediction, and if this flag is 1, the reference line group is signaled by this implementation to determine which reference line to use. If selective_mrl_flag is not present, selective_mrl_flag may be inferred to be 0.

ref_group_idx indicates the determined reference line group and may have a value of 0 or more.

ref_group_candidate_idx is a reference line candidate index indicating a reference line to be used within the determined reference line group. The ref_group_candidate_idx indicates a selected reference line within the reference line group and may have a value of 0 or more.

Preferred pseudocode according to this implementation may be realized as follows.

```
Parse selective MRL flag (selective_mrl_flag)
if (selective MRL applied)
  Parse reference line group index (ref_group_idx)
  Parse reference line candidate index (ref_group_candidate_idx)
Parse intra-prediction mode
```

Here, either the intra-prediction mode or the selective MRL flag may be parsed first. The ref_group_candidate_idx is parsed if the reference line is determined by signaling the reference line, and is not parsed if ref_group_candidate_idx is inferred.

According to the pseudocode described above, a syntax for transmission is shown in Table 4. In Table 4, the selective MRL flag is parsed first, and then the reference line candidate index is parsed from the determined reference line group.

```
TABLE 4
} else {
  if( sps_selective_mrl_enabled_flag)
    selective_mrl_flag
  if( selective_mrl_flag = = 1 ) {
    ref_group_idx
    ref_group_candidate_idx
  }
  if( sps_isp_enabled_flag && selective_mrl_flag = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( selective_mrl_flag = = 0 )
    intra_luma_mpm_flag[ x0 ][ y0 ]
  if( intra_luma_mpm_flag[ x0 ][ y0 ] ) {
    if( selective_mrl_flag = = 0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

### Implementation 1-2: Inferring Reference Line Group

In this implementation, the video decoding device infers one of multiple reference line groups. According to the block features, (Implementation 1-2-1) the reference line group may be selected or (Implementation 1-2-2) a preset reference line group may be used.

### Implementation 1-2-1: Selecting Reference Line Group According to Block Features

In this implementation, the video decoding device selects one of multiple reference line groups based on block features. Referenced as block features may be at least one or more of W, H, log₂ W, log₂ H, log₂ WH, WH, log₂(W/H), W/H, log₂(H/W), H/W related to width, height, area, and aspect ratio. These features are further detailed as follows, of which at least one may be referenced. Hereinafter, the distance between a block and a reference line may be an index value of the reference line, the number of pixels between the two, the number of blocks between the two, and the like.

First, referenced as current block's features may include the position, prediction mode, reference pixel, any predictors that can be generated, distance between the current block and the available reference line included in the selected reference line group, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

The features of the adjacent block of the current block described in Implementation 1-1-2 may be referenced.

The features of a reconstructed block that is temporally earlier than the current block described in Implementation 1-1-2 may be referenced.

Referenced also may be the features of the collocated block with the current block in another referenceable picture and the adjacent block of the collocated block, which are described in Implementation 1-1-2.

The referencing of the features of the collocated block with the current block in another referenceable picture and the adjacent block of the collocated block may be applicable more preferably or according to embodiments exclusively when the current block uses the intra mode in the inter slice.

An example of inferring a reference line group based on a feature of the referenced block is as follows. For example, if the area (log₂ WH) of a block is referenced as a block feature, the reference line group may be determined differently depending on the area of the current block, as shown in Table 5.

TABLE 5

| Block size (log₂WH) | Reference line group |
|---|---|
| Block size < 8 | {intra_luma_ref_idx 0, intra_luma_ref_idx 1, |
| | intra_luma_ref_idx 2} |
| Block size ≥ 8 | {intra_luma_ref_idx 0, intra_luma_ref_idx 1} |

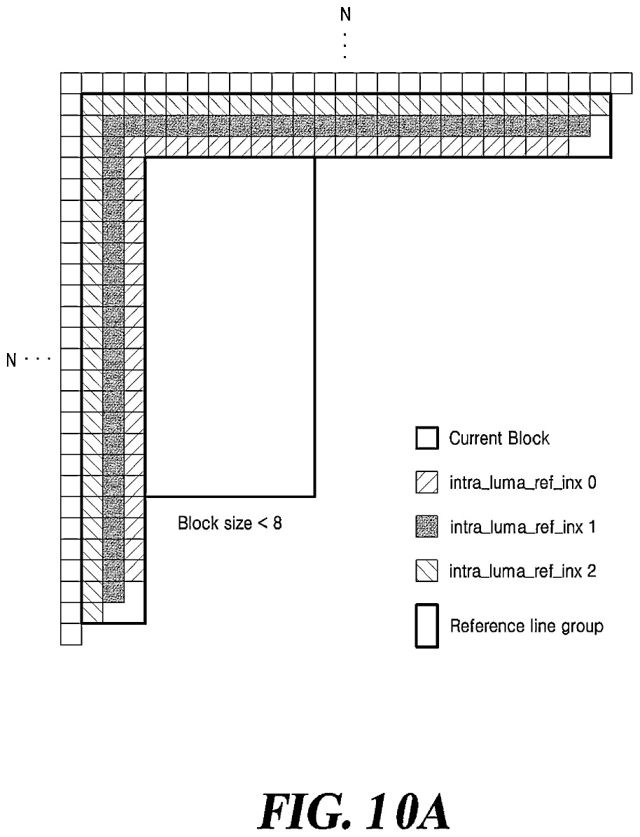

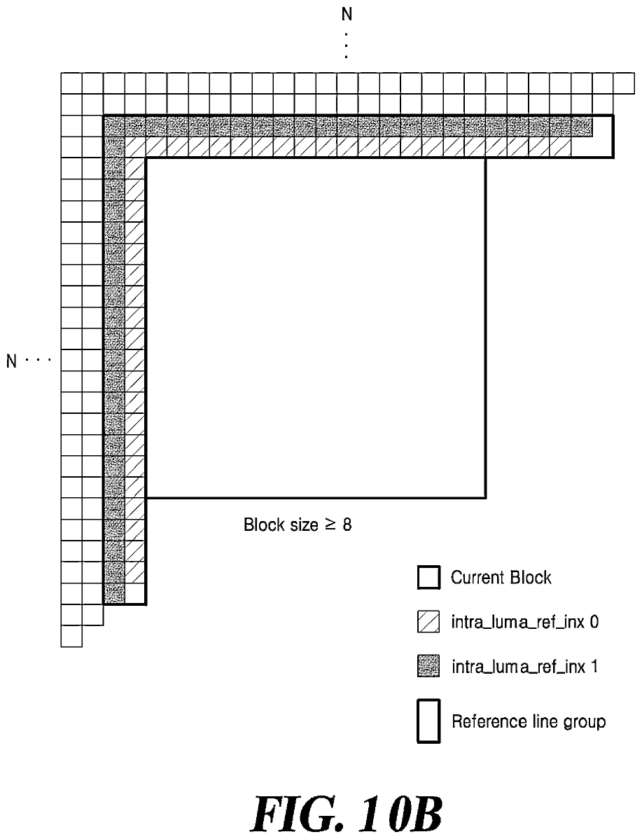

FIGS. 10A and 10B are diagrams illustrating the inference of a reference line group, according to at least one embodiment of the present disclosure.

In the example of FIG. 10A, since the current block has a width of 8 and a height of 16 with log₂ WH=7, the reference line group is determined to be {intra_luma_ref_idx 0, intra_luma_ref_idx 1, intra_luma_ref_idx 2} according to Table 5. Further, one reference line from the reference line group is selected and used for prediction.

In the example of FIG. 10B, since the current block has a width of 16 and a height of 16 with log₂ WH=8, the reference line group is determined to be {intra_luma_ref_idx 0, intra_luma_ref_idx 1} according to Table 5. Further, one reference line from the reference line group is selected and used for prediction.

Then, among the reference lines included in the selected one reference line group, the reference line to be used for prediction, i.e., the reference line candidate index, may be (Implementation 1-2-1-1) signaled or (Implementation 1-2-1-2) inferred. The following describes the case where ref_group_candidate_idx indicates which reference line is to be used within the determined reference line group.

### Implementation 1-2-1-1: Signaling Reference Line Candidate Index

In this implementation, the video encoding device may signal the reference line candidate index ref_group_candidate_idx to indicate which reference line is to be used within the selected reference line group. According to Table 3, if ‘Group 1’ is selected and ref_group_candidate_idx 2 is signaled, intra_luma_ref_idx 8 is used for the prediction of the current block. If there is only one reference line within the selected reference line group, the video decoding device may still parse ref_group_candidate_idx, or may omit the parse and may infer ref_group_candidate_idx to be 0.

### Implementation 1-2-1-2: Inferring Reference Line Candidate Index

In this Implementation, when a ref_group_candidate_idx is inferred, the video decoding device may infer ref_group_candidate_idx (i.e., a reference line) used according to a block feature or may use a reference line preset at a higher level such as SPS, PPS, and the like. Referenced here as the block feature may be at least one of the block width, height, area, aspect ratio and shape. These features are further detailed as follows, of which at least one may be referenced. Hereinafter, the distance between a block and a reference line may be an index value of the reference line, the number of pixels between the two, the number of blocks between the two, and the like.

First, referenced as current block's features may include the position, prediction mode, reference pixel, any predictors that can be generated, distance between the current block and the available reference line included in the reference line group determined according to the predetermined method, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

The features of the adjacent block of the current block described in Implementation 1-1-2 may be referenced.

The features of a reconstructed block that is earlier than the current block described in Implementation 1-1-2 may be referenced.

Referenced also may be the features of the collocated block with the current block in another referenceable picture and the adjacent block of the collocated block, which are described in Implementation 1-1-2.

The referencing of the features of the collocated block with the current block in another referenceable picture and the adjacent block of the collocated block may be applicable more preferably or according to embodiments exclusively when the current block uses the intra mode in the inter slice.

Examples of inferring ref_group_candidate_idx based on the feature of the block to be referenced are as follows.

For example, if an area is referenced as a block feature, the larger the area of the block, the larger the reference line in its ref_group_candidate_idx, which is the value of the index in the selected reference line group, may be used for prediction. Alternatively, the reference line with a smaller index value may be used for prediction. Alternatively, when reference lines that are determined at a higher level such as SPS, PPS, and the like are used, the video decoding device may use, for prediction, the reference line indicated by sps_ref_group_candidate_idx, pps_ref_group_candidate_idx, and the like from the reference line group selected respectively by all CUs or some CUs. For example, if sps_ref_group_candidate_idx is 1, the reference line with ref_group_candidate_idx 1 in the reference line group may always be used.

The syntax elements according to this implementation are as follows. At least one of these or multiple syntax elements may be used.

selective_mrl_flag is a flag that indicates whether the selective MRL is applied, and may have values of 0 and 1. If this flag is 0, intra_luma_ref_idx 0 is used for prediction, and if this flag is 1, a reference line group is inferred by this implementation to determine which reference line to use. If selective_mrl_flag is not present, selective_mrl_flag may be inferred to be 0.

ref_group_candidate_idx is a reference line candidate index indicating a reference line to be used within the determined reference line group. ref_group_candidate_idx indicates a selected reference line within the reference line group and may have a value of 0 or greater.

Preferred pseudocode according to this implementation may be realized as follows.

Parse selective MRL flag (selective_mrl_flag)
if (selective MRL applied)
Parse reference line candidate index (ref_group_candidate_idx)
Parse intra-prediction mode

Here, either the intra-prediction mode or the selective MRL flag may be parsed first. The ref_group_candidate_idx is parsed if the reference line is determined by signaling the reference line, and is not parsed if the reference line is inferred.

According to the pseudocode described above, a syntax for transmission is shown in Table 6. In Table 6, the selective MRL flag is parsed first, and then the reference line candidate index is parsed from the determined reference line group.

```
TABLE 6
} else {
  if( sps_selective_mrl_enabled_flag)
    selective_mrl_flag
  if( selective_mrl_flag = = 1 )
    ref_group_candidate_idx
  if( sps_isp_enabled_flag && selective_mrl_flag = = 0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( selective_mrl_flag = = 0 )
    intra_luma_mpm_flag[ x0 ][ y0 ]
  if( intra_luma_mpm_flag[ x0 ][ y0 ] ) {
    if( selective_mrl_flag = = 0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

### Implementation 1-2-2: Using Preset Reference Line Group

In this implementation, the video decoding device uses a preset reference line group. One of the K reference line groups is set at a higher level such as SPS, PPS, and the like and the preset reference line group may be used commonly for all CUs or some CUs. The pps_ref_group_idx indicates the reference line group determined at the PPS, and the sps_ref_group_idx indicates the reference line group determined at the SPS. As an example, if sps_ref_group_idx 1 is signaled, ‘Group 1’ may be selected.

Thereafter, among the reference lines included in one preset reference line group, the reference line to be used for prediction, i.e., the reference line candidate index, may be (Implementation 1-2-2-1) signaled or (Implementation 1-2-2-2) inferred. The following is a description of the case where ref_group_candidate_idx indicates which reference line is to be used within the determined reference line group.

### Implementation 1-2-2-1: Signaling Reference Line Candidate Index

In this implementation, the video encoding device may signal the reference line candidate index ref_group_candidate_idx to indicate which reference line is to be used within the selected reference line group. In Table 3, if ‘Group 1’ is selected and ref_group_candidate_idx 2 is signaled, intra_luma_ref_idx 8 is used for the prediction of the current block. If only one reference line exists within the selected reference line group, the video decoding device may still parse ref_group_candidate_idx, or may omit the parse and may infer ref_group_candidate_idx to be 0.

### Implementation 1-2-2-2: Inferring Reference Line Candidate Index

In this implementation, when a ref_group_candidate_idx is inferred, the video decoding device may infer ref_group_candidate_idx (i.e., a reference line) used according to a block feature or may use a reference line preset at a higher level such as SPS, PPS, and the like. Referenced here as the block feature may be at least one of the block width, height, area, aspect ratio and shape. These features are further detailed as follows, of which at least one may be referenced. Hereinafter, the distance between a block and a reference line may be an index value of the reference line, the number of pixels between the two, the number of blocks between the two, and the like.

First, referenced as current block's features may include the position, prediction mode, reference pixel, any predictors that can be generated, distance between the current block and the available reference line included in the selected reference line group determined by a predetermined method, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

The features of the adjacent block of the current block described in Implementation 1-1-2 may be referenced.

The features of a reconstructed block that is earlier than the current block described in Implementation 1-1-2 may be referenced.

Referenced also may be the features of the collocated block with the current block in another referenceable picture and the adjacent block of the collocated block, which are described in Implementation 1-1-2.

The referencing of the features of the collocated block with the current block in another referenceable picture and the adjacent block of the collocated block may be applicable more preferably or according to embodiments exclusively when the current block uses the intra mode in the inter slice.

An example of inferring a reference line group based on the feature of the block being referenced is as follows.

For example, if an area is referenced as a block feature, the larger the area of the block, the larger the reference line in its ref_group_candidate_idx, which is the value of the index in the selected reference line group, may be used for prediction. Alternatively, the reference line with a smaller index value may be used for prediction. Alternatively, when reference lines that are determined at a higher level such as SPS, PPS, and the like are used, the video decoding device may use, for prediction, the reference line indicated by sps_ref_group_candidate_idx, pps_ref_group_candidate_idx, and the like. from the reference line group selected respectively by all CUs or some CUs. For example, if sps_ref_group_candidate_idx is 1, the reference line with ref_group_candidate_idx 1 in the reference line group may always be used.

The syntax elements according to this implementation are as follows. At least one of these or multiple syntax elements may be used.

selective_mrl_flag is a flag that indicates whether the selective MRL is applied, and may have values of 0 and 1. If this flag is 0, intra_luma_ref_idx 0 is used for prediction, and if this flag is 1, the reference line group is inferred by this implementation to determine which reference line to use. If selective_mrl_flag is not present, selective_mrl_flag may be inferred to be 0.

ref_group_candidate_idx is a reference line candidate index indicating a reference line to be used within the determined reference line group. ref_group_candidate_idx indicates the selected reference line within the reference line group and may have a value greater than or equal to 0.

The preferred pseudocode according to this implementation may be the same as the pseudocode of Implementation 1-2-1. Here, either the intra-prediction mode or the selective MRL flag may be parsed first. The ref_group_candidate_idx is parsed if the reference line is determined by signaling the reference line, and not parsed if the reference line is inferred. Additionally, the syntax for transmission may be the same as Table 6 which shows the syntax of Implementation 1-2-1.

### Implementation 2: Generating a New Reference Line

In this implementation, to selectively use multiple reference lines, the video decoding device generates a new reference line by weighted combining the multiple reference lines. The video decoding device may weighted-combine the reference lines according to Equation 2.

$$luma\_ref {\_line}_{n e w} = {w}_{i} \times luma\_ref {\_line}_{i} + {w}_{j} \times luma\_ref {\_line}_{j} \qquad Equation 2$$

Here, luma_ref_lineᵢ denotes the reference line indicated by intra_luma_ref_idx i, and luma_ref_line_{new} denotes the new reference line generated by the weighted combination. Additionally, the sum of the weights satisfies 1 (wᵢ+wⱼ=1, where each weight value may be 0). In Equation 2, two reference lines are weighted and combined, but this is not necessarily the case. n (n>2) reference lines may also be weighted and combined.

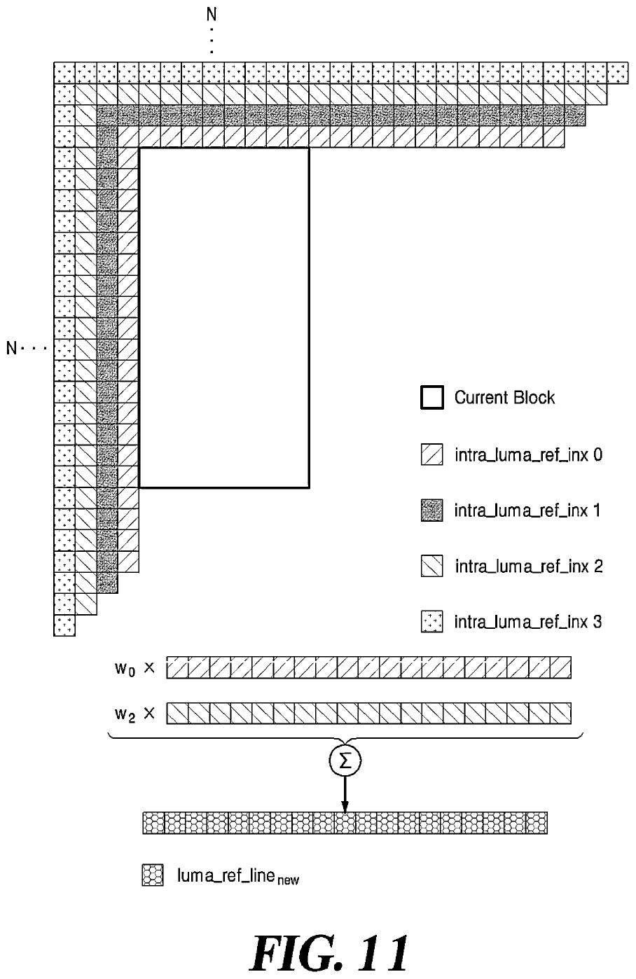

FIG. 11 is a diagram illustrating a weighted combination of two reference lines, according to at least one embodiment of the present disclosure.

When the reference lines are weighted and combined, the present disclosure may take into account the directionality of the intra-prediction mode to select the pixels per reference line, which are used to calculate the value of each pixel in the new reference line. For example, a case is described where the value of the x-coordinate increases from left to right for the x-axis in the horizontal direction, and the value of the y-coordinate increases from top to bottom for the y-axis in the vertical direction, the prediction mode is a vertical prediction mode (prediction mode 50), and the position of the top-left pixel of the current block is (x0, y0). As shown in the example of FIG. 11, in each reference line, a new pixel is generated by weighted-combining the pixels at positions (x, y0-1) and (x, y0-3) wherein x0≤ x≤x0+W−1 The pixels are indicated by the vertical mode. The following describes a method of generating a new reference line, including (Implementation 2-1) a method of determining multiple reference lines, and (Implementation 2-2) a method of determining weights.

### Implementation 2-1: Determining Multiple Reference Lines

In this implementation, the video decoding device determines multiple reference lines for weighted combining. For this purpose, the video decoding device may (Implementation 2-1-1) utilize a reference line group or may (Implementation 2-1-2) not utilize a reference line group.

### Implementation 2-1-1: Using a Reference Line Group

In this implementation, the video decoding device determines multiple reference lines by using a reference line group. The reference line group may be selected according to Implementation 1. Example methods used may include (Implementation 1-1) signaling a reference line group, (Implementation 1-2-1) inferring a reference line group based on a block feature, and (Implementation 1-2-2) using a preset reference line group. The respective methods may be realized with their required syntaxes, depending on Implementation 1.

As in Implementation 1, whether or not selective MRL is applied may be indicated by the selective MRL flag, selective_mrl_flag. If this flag is 0, indicating that this implementation of weighted combining of multiple reference lines is not used for prediction in the current block, then intra_luma_ref_idx 0 may be used as a single reference line. Alternatively, intra_luma_ref_idx may be further parsed to signal a single reference line to be used for prediction from the multiple reference lines. After the reference line group is determined according to Implementation 1, the video decoding device may use all reference lines within that reference line group for weighted combining.

An example considers a case where a reference line group is determined according to (Implementation 1-1) the signaling of the reference line group. If there are three reference line groups, as shown in Table 3, and ref_group_idx is signaled as 1, the reference lines indicated by the three reference line indices of intra_luma_ref_idx 0, intra_luma_ref_idx 4, and intra luma_ref_idx 8 included in ‘Group 1’ may be used for weighted combining, as shown in Equation 3.

$$luma\_ref {\_line}_{n e w} = {w}_{0} \times luma\_ref {\_line}_{0} + {w}_{4} \times luma\_ref {\_line}_{4} + {w}_{8} \times luma\_ref {\_line}_{8} \qquad Equation 3$$

### Implementation 2-1-2: Not Utilizing a Reference Line Group

In this implementation, the video decoding device determines multiple reference lines without using a reference line group. This may be accomplished by (Implementation 2-1-2-1) signaling the multiple reference lines, by (Implementation 2-1-2-2) using the reference lines determined by the block feature, or by (Implementation 2-1-2-3) using predetermined multiple reference lines.

### Implementation 2-1-2-1: Signaling Multiple Reference Lines

In this implementation, the video encoding device signals multiple reference lines to the video decoding device. The video decoding device may determine which reference lines are used to generate the new reference lines by first parsing num_refLine, which represents the number of the multiple reference lines to be used for prediction for each block at the CU level, and then parsing the reference line index by that value. In this case, num_refLine may be unsignaled and a fixed value may be used regardless of the block. If num_refLine is 1, then intra_luma_ref_idx 0 may be used as the single reference line, since current block's prediction uses one reference line and rules out this implementation of weighted combining of multiple reference lines. Alternatively, intra_luma_ref_idx may be further parsed to signal a single reference line to be used for prediction among the multiple reference lines.

The syntax elements according to this implementation are as follows. At least one of these or a plurality of syntax elements may be used.

num_refLine indicates the number of reference lines to be used in the prediction and has a value of one or greater. When num_refLine is 1, intra_luma_ref_idx 0 may be used steadily as a single reference line, or intra_luma_ref_idx may be further parsed to select one reference line from the multiple reference lines to be used in the prediction. If num_refLine is not 1, the video decoding device parses the reference line index by the magnitude of num_refLine. If num_refLine does not exist, num_refLine may be inferred to be 1.

intra_luma_ref_indices indicates the reference line indices as many as num_refLine to be used for weighted combining of the reference lines. Each index is 0 or greater and may have different values.

intra_luma_ref_idx indicates one reference line index of the multiple reference lines. In this implementation, intra_luma_ref_idx may be signaled when num_refLine is 1. The intra_luma_ref_idx may have different values of 0 or greater.

Preferred pseudocode according to this implementation may be realized as follows.

```
Parse the number of reference lines to be used for prediction
(num_refLine)
if (case of using multiple reference lines for prediction)
  Parse multiple reference line indices (intra_luma_ref_indices)
else (case of using a single reference lines for prediction)
  Parse a single reference line index (intra_luma_ref_idx)
Parse intra-prediction mode
```

Here, when num_refLine, the number of multiple reference lines, is used as a fixed value regardless of the block, the parsing of num_refLine is omitted and the predetermined value is used as num_refLine. Either the intra-prediction mode or the information on the reference line may be parsed first. The pseudocode described above is an example of parsing intra_luma_ref_idx to determine the reference line when num_refLine is 1. Thus, if num_refLine is 1 and intra_luma_ref_idx 0 is used steadily, the parsing of that syntax may be omitted.

According to the pseudocode described above, a syntax for transmission is shown in Table 7. In Table 7, information on the reference line is parsed first, and if num_refLine is 1, the reference line is determined by parsing intra_luma_ref_idx.

```
TABLE 7
} else {
  if( sps_selective_mrl_enabled_flag )
    num_refLine
  if( num_refLine ! = 1 )
    intra_luma_ref_indices
  else
    intra_luma_ref_idx
  if(sps_isp_enabled_flag&& num_refLine = = 1 &&
  intra_luma_ref_idx= =0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( num_refLine = = 1 && intra_luma_ref_idx == 0)
    intra_luma_mpm_flag[ x0 ][ y0 ]
  if( intra_luma_mpm_flag[ x0 ][ y0 ] ) {
    if( num_refLine = = 1 && intra_luma_ref_idx == 0)
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
  }
```

### Implementation 2-1-2-2: Using the Number of Reference Lines Determined by Block Feature

In this implementation, the video decoding device uses a predetermined number of reference lines based on the block feature. For example, this implementation may take into account the distance between the reference line used for prediction and the block side facing the reference line. For this purpose, the height of the block is considered for prediction modes of vertical mode 50 or higher that use the top reference line for prediction, and the width of the block is considered for prediction modes of horizontal mode 18 or lower that use the left reference line for prediction. The greater of the width and height of the block may be considered for prediction modes greater than horizontal mode 18 and less than vertical mode 50 that use both the top and left reference lines for prediction. The video decoding device may determine multiple reference lines based on the width or height of the considered block, such that the larger the distance, the more reference lines may be used to improve prediction accuracy, as shown in Table 8. Alternatively, the smaller the distance, the fewer reference lines may be used.

TABLE 8

| Block Size(Width | Reference Lines Used for |
|---|---|
| or Height) | Weighted Combining |
| 4 | One (intra_luma_ref_idx 0) |
| 8 or 16 | Two (intra_luma_ref_idx 0, 1) |
| 32 or 64 | Three (intra_luma_ref_idx 1, 2, 3) |
| . | . |
| . | . |
| . | . |

Additionally referenced may be at least one of the block's area, prediction mode, and aspect ratio as block features to determine multiple reference lines to be used for prediction. These features are further detailed as follows, of which at least one may be referenced. Hereinafter, the distance between a block and a reference line may be an index value of the reference line, the number of pixels between the two, the number of blocks between the two, and the like.

First, referenced as current block's features may include the position, prediction mode, reference pixel, any predictors that can be generated, distance between the available reference line and the current block, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

Referenced as features of an adjacent block of the current block may be such features as the position, the pixel value from the block reconstructed, prediction mode, reference line used for prediction, whether MRL is used, whether this implementation is used, information considered when this implementation is used, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, whether MRL is used, whether this implementation is used, information considered when this implementation is used, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and an adjacent block of the collocated block have features that may be referenced such as the position, the pixel value from the block reconstructed, prediction mode, reference line used for prediction, whether MRL is used, whether this implementation is used, information considered when this implementation is used, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

As in Implementation 1, whether or not selective MRL is applied may be indicated by the selective MRL flag, selective_mrl_flag. If this flag is 0, indicating that this implementation of weighted combining of multiple reference lines is not used in the prediction of the current block, then intra_luma_ref_idx 0 may be used as a single reference line. Alternatively, intra_luma_ref_idx may be further parsed to signal a single reference line to be used for prediction from the multiple reference lines.

The syntax elements according to this implementation are as follows. At least one of these or a plurality of syntax elements may be used.

selective_mrl_flag is a flag that indicates whether the selective MRL is applied, and may have values of 0 and 1. If this flag is 0, intra_luma_ref_idx 0 may be used steadily for prediction, or intra_luma_ref_idx may be further parsed to select one reference line to be used for prediction from the multiple reference lines. If this flag is 1, the reference line group is signaled according to this implementation to determine which reference line to use. If selective_mrl_flag is not present, selective_mrl_flag may be inferred to be 0.

intra_luma_ref_idx indicates one reference line index of the multiple reference lines. In this implementation, intra_luma_ref_idx may be signaled if selective_mrl_flag is 0. The intra_luma_ref_idx may have different values of 0 or greater.

Preferred pseudocode according to this implementation may be realized as follows

Parse selective MRL flag (selective_mrl_flag)
if (selective MRL not applied)
Parse a single reference line index (intra_luma_ref_idx)
Parse intra-prediction mode

Here, either the intra-prediction mode or the selective MRL flag may be parsed first. The above pseudocode is an example of parsing intra_luma_ref_idx to determine the reference line when selective_mrl_flag is 0. Thus, if selective_mrl_flag is 0 and intra_luma_ref_idx 0 is used steadily, the parsing of that syntax may be omitted.

According to the pseudocode described above, a syntax for transmission is shown in Table 9. In Table 9, the selective MRL flag is parsed first, and if selective_mrl_flag is 0, intra_luma_ref_idx is parsed to determine the reference line.

```
TABLE 9
} else {
  if( sps_adaptive_mrl_enabled_flag && ( ( y0 % CtbSizeY ) > 0 ) )
    selective_mrl_flag
  if( selective_mrl_flag == 0)
    intra_luma_ref_idx
  if(sps_isp_enabled_flag&&selective_mrl_flag==0&&intra_luma_ref_idx==0&&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( selective_mrl_flag = = 0&& intra_luma_ref_idx==0 )
    intra_luma_mpm_flag[ x0 ][ y0 ]
  if( intra_luma_mpm_flag[ x0 ][ y0 ] ) {
    if( selective_mrl_flag = = 0&& intra_luma_ref_idx==0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

### Implementation 2-1-2-3: Using Predefined Multiple Reference Lines

In this implementation, the video decoding device uses multiple reference lines defined at a higher level, such as SPS, PPS, and the like. For example, a new reference line may be generated by weighted combining two reference lines, intra_luma_ref_idx 0 and intra_luma_ref_idx 2, as shown in Equation 4.

$$luma\_ref {\_line}_{n e w} = {w}_{0} \times luma\_ref {\_line}_{0} + {w}_{2} \times luma\_ref {\_line}_{2} \qquad Equation 4$$

As in Implementation 1, whether or not selective MRL is applied may be indicated by the selective MRL flag, selective_mrl_flag. If this flag is 0, indicating that this implementation of weighted combining of multiple reference lines is not used for prediction in the current block, then intra_luma_ref_idx 0 may be used as a single reference line. Alternatively, intra_luma_ref_idx may be further parsed to signal a single reference line to be used for prediction out of the multiple reference lines.

The syntax elements according to this implementation are as follows. At least one of these or a plurality of syntax elements may be used.

selective_mrl_flag is a flag that indicates whether the selective MRL is applied, and may have values of 0 and 1. If this flag is 0, intra_luma_ref_idx 0 may be used steadily for the prediction, or intra_luma_ref_idx may be further parsed to select one reference line to be used for prediction from the multiple reference lines. If this flag is 1, the reference line group is signaled according to this implementation to determine which reference line to use. If selective_mrl_flag is not present, selective_mrl_flag may be inferred to be 0.

intra_luma_ref_idx indicates one reference line index of the multiple reference lines. In this implementation, intra_luma_ref_idx may be signaled if selective_mrl_flag is 0. intra_luma_ref_idx may have different values of 0 or greater.

A preferred pseudocode according to this implementation may be the same as the pseudocode of Implementation 2-1-2-2. Here, either the intra-prediction mode or the selective MRL flag may be parsed first. The pseudocode mentioned above is an example of parsing intra_luma_ref_idx to determine the reference line when selective_mrl_flag is 0. Therefore, if selective_mrl_flag is 0 and intra_luma_ref_idx 0 is used steadily, the parsing of the relevant syntax may be omitted. Additionally, the syntax for transmission may be the same as Table 6 which shows the syntax of Implementation 2-1-2-2.

### Implementation 2-2: Determining Weights

In this implementation, the video decoding device determines the weights of each reference line for weighted-combining different reference lines. The following describes a method of determining the weights, which is (Implementation 2-2-1) a method of using predefined weights, and a method of signaling the weights.

### Implementation 2-2-1: Using Predefined Weights

In this implementation, the video decoding device uses predefined weights. The predefined weights may include equal weights per reference line, e.g., 1:1 for two reference lines, 1:1:1 for three reference lines, and the like, or the higher weights the closer the distance between the reference lines and the current block, e.g., 3:1 for two reference lines, 2:1:1 for three reference lines, and the like.

For example, when a new reference line is generated based on two reference lines, intra_luma_ref_idx 0 and intra_luma_ref_idx 2, all reference lines may be weighted equally, as shown in Equation 5.

$$luma\_ref {\_line}_{n e w} = \frac{1}{2} \times luma\_ref {\_line}_{0} + \frac{1}{2} \times luma\_ref {\_line}_{2} \qquad Equation 5$$

Alternatively, a higher weight may be set for reference lines that are close to the current block, as shown in Equation 6.

$$luma\_ref {\_line}_{n e w} = \frac{3}{4} \times luma\_ref {\_line}_{0} + \frac{1}{4} \times luma\_ref {\_line}_{2} \qquad Equation 6$$

### Implementation 2-2-1: Signaling Weights

In this implementation, the video encoding device signals the weights to the video decoding device.

When multiple reference lines are determined according to Implementation 2-1-2-1, the video encoding device signals a plurality of reference line indices for each block at the CU level and then signals the weights used to generate a new reference line based on those reference lines. The weights may be represented by generate_ref_weight which may be used to signal the appropriate weight value for each reference line.

If the multiple reference lines are determined without any signaling, such as in Implementation 2-1-2-2 or Implementation 2-1-2-3, the video encoding device may signal the weights in order, i.e., in order of proximity to the current block, beginning with the weight corresponding to the smallest of the plurality of reference line indices. Alternatively, the weights may be signaled in reverse order.

If multiple reference lines are determined by using a reference line group, such as in Implementation 2-1-1, the video encoding device signals the weight of each reference line in a random order within the selected reference line group. The random order may be a descending or ascending order of ref_group_candidate_idx, the order of the reference lines as arranged within the reference line group, or a descending or ascending order of intra_luma_ref_idx values which represent the index values of the respective reference lines. Further, if there is only one reference line within the selected reference line group, the weight may be considered to be 1 without being signaled, which is equivalent to performing the prediction with a single reference line.

The syntax elements according to this implementation are as follows. At least one of these or a plurality of syntax elements may be used.

selective_mrl_flag is a flag that indicates whether the selective MRL is applied, and may have values of 0 and 1. If this flag is 0, intra_luma_ref_idx 0 may be used steadily for prediction, or intra_luma_ref_idx may be further parsed to select one reference line to be used for prediction from the multiple reference lines. If this flag is 1, multiple reference lines are determined by this implementation. If selective_mrl_flag is not present, selective_mrl_flag may be inferred to be 0.

num_refLine indicates the number of reference lines to be used in the prediction and has a value of one or greater. When num_refLine is 1, intra_luma_ref_idx 0 may be used steadily as a single reference line, or intra_luma_ref_idx may be further parsed to select one reference line from the multiple reference lines to be used in the prediction. If num_refLine is not 1, the video decoding device parses the reference line index by the magnitude of num_refLine. If num_refLine does not exist, num_refLine may be inferred to be 1.

intra_luma_ref_indices represents the reference line indices as many as num_refLine used for prediction. Each index is 0 or greater and may have different values.

intra_luma_ref_idx indicates one reference line index of the multiple reference lines. In this implementation, intra_luma_ref_idx may be signaled when the multiple reference lines are determined according to Implementation 2-1-2-1 and num_refLine is 1. Alternatively, intra_luma_ref_idx may be signaled when the multiple reference lines are determined without any signaling as in Implementation 2-1-2-2 or Implementation 2-1-2-3, and selective_mrl_flag is 0. intra_luma_ref_idx may have different values of 0 or greater.

ref_group_idx indicates the determined reference line group and may have a value or 0 or greater.

generate_ref_weight indicates the weight that each reference line uses for weighted combining to generate a new reference line.

When multiple reference lines are signaled and determined according to Implementation 2-1-2-1, the preferred pseudocode according to this implementation may be realized as follows.

```
Parse the number of reference lines to be used for prediction
(num_refLine)
if (case of using multiple reference lines for prediction)
    Parse multiple reference line indices (intra_luma_ref_indices)
  Parse weight of each reference line (generate_ref_weight)
else (case of using a single reference lines for prediction)
  Parse a single reference line index (intra_luma_ref_idx)
Parse intra-prediction mode
```

Here, if num_refLine, the number of reference lines, is used as a fixed value regardless of the block, the parsing of num_refLine is omitted and a predetermined value is used as num_refLine. Either the intra-prediction mode or information on the reference line may be parsed first. The above pseudocode is an example of parsing intra_luma_ref_idx to determine the reference line when num_refLine is equal to 1. Thus, if num_refLine is 1 and intra_luma_ref_idx 0 is used steadily, the parsing of that syntax may be omitted.

According to the pseudocode described above, a syntax for transmission is shown in Table 10. In Table 10, the information on the reference line is parsed first, and if num_refLine is 1, intra_luma_ref_idx is parsed to determine the reference line.

```
TABLE 10
} else {
  if( sps_selective_mrl_enabled_flag )
    num_refLine
  if( num_refLine ! = 1 ) {
    intra_luma_ref_indices
    generate_ref_weight
  } else
    intra_luma_ref_idx
  if(sps_isp_enabled_flag&& num_refLine = = 1 &&
  intra_luma_ref_idx= =0 &&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( num_refLine = = 1 && intra_luma_ref_idx == 0)
    intra_luma_mpm_flag[ x0 ][ y0 ]
  if( intra_luma_mpm_flag[ x0 ][ y0 ] ) {
    if( num_refLine = = 1 && intra_luma_ref_idx == 0)
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

When the multiple reference lines are determined without any signaling as in Implementation 2-1-2-2 or Implementation 2-1-2-3, the preferred pseudocode according to this implementation may be realized as follows.

```
Parse selective MRL flag (selective_mrl_flag)
if (selective MRL applied)
  Parse weight of each reference line (generate_ref_weight)
else (selective MRL not applied)
  Parse a single reference line index (intra_luma_ref_idx)
Parse intra-prediction mode
```

Here, either the intra-prediction mode or the selective MRL flag may be parsed first. The above pseudocode is an example of parsing intra_luma_ref_idx to determine the reference line when selective_mrl_flag is 0. Thus, if selective_mrl_flag is 0 and intra_luma_ref_idx 0 is used steadily, the parsing of that syntax may be omitted.

According to the pseudocode described above, a syntax for transmission is shown in Table 11. In Table 11, the selective MRL flag is parsed first, and if selective_mrl_flag is 0, intra_luma_ref_idx is parsed to determine the reference line.

```
TABLE 11
} else {
  if( sps_adaptive_mrl_enabled_flag )
    selective_mrl_flag
  if( selective_mrl_flag == 1)
    generate_ref_weight
  else
    intra_luma_ref_idx
  if(sps_isp_enabled_flag&&selective_mrl_flag==0&&intra_luma_ref_idx==0&&
      ( cbWidth <= MaxTbSizeY && cbHeight <= MaxTbSizeY ) &&
      ( cbWidth * cbHeight > MinTbSizeY * MinTbSizeY ) &&
      !cu act_enabled_flag )
    intra_subpartitions_mode_flag
  if( intra_subpartitions_mode_flag = = 1 )
    intra_subpartitions_split_flag
  if( selective_mrl_flag = = 0 && intra_luma_ref_idx==0 )
    intra_luma_mpm_flag[ x0 ][ y0 ]
  if( intra_luma_mpm_flag[ x0 ][ y0 ] ) {
    if( selective_mrl_flag = = 0 && intra_luma_ref_idx==0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

When the multiple reference lines are determined by using a reference line group as in Implementation 2-1-1, the preferred pseudocode according to this implementation may be realized as follows.

```
Parse selective MRL flag (selective_mrl_flag)
if (selective MRL applied)
  Parse reference line group index (ref_group_idx)
    Parse weight of each reference line (generate_ref_weight)
else (selective MRL not applied)
    Parse a single reference line index (intra_luma_ref_idx)
Parse intra-prediction mode
```

Here, either the intra-prediction mode or the selective MRL flag may be parsed first. If a reference line group is inferred, the parsing of ref_group_idx syntax may be omitted. The above pseudocode is an example of parsing intra_luma_ref_idx to determine the reference line when selective_mrl_flag is 0. Thus, if selective_mrl_flag is 0 and intra_luma_ref_idx 0 is used steadily, the parsing of that syntax may be omitted.

According to the pseudocode described above, a syntax for transmission is shown in Table 12. In Table 12, the selective MRL flag is parsed first, and if selective_mrl_flag is 0, intra_luma_ref_idx is parsed to determine the reference line.

```
TABLE 12
} else {
  if( sps_adaptive_mrl_enabled_flag )
    selective_mrl_flag
  if( selective_mrl_flag == 1) {
    ref_group_idx
    generate_ref_weight
  } else
    intra_luma_ref_idx
  if(sps_isp_enabled_flag&&selective_mrl_flag==0&&intra_luma_ref_idx==0&&
      ( cbWidth <= MaxTbSizeY && cbHeight <= MaxTbSizeY ) &&
      ( cbWidth * cbHeight > MinTbSizeY * MinTbSizeY ) &&
      !cu_act_enabled_flag )
    intra_subpartitions_mode_flag
  if( intra_subpartitions_mode_flag = = 1 )
    intra_subpartitions_split_flag
  if( selective_mrl_flag = = 0 && intra_luma_ref_idx==0 )
    intra_luma_mpm_flag[ x0 ][ y0 ]
  if( intra_luma_mpm_flag[ x0 ][ y0 ] ) {
    if( selective_mrl_flag = = 0 && intra_luma_ref_idx==0 )
      intra_luma_not_planar_flag[ x0 ][ y0 ]
    if( intra_luma_not_planar_flag[ x0 ][ y0 ] )
      intra_luma_mpm_idx[ x0 ][ y0 ]
  } else
    intra_luma_mpm_remainder[ x0 ][ y0 ]
}
```

### Implementation 3: Controlling Available Reference Lines

In this implementation, the video decoding device does not use all N available reference lines for prediction of the current block but instead controls the use of some of the available reference lines based on certain conditions. For blocks that do not meet certain conditions, when MRL is used the video decoding device selects a reference line by applying prior art methods, implementations of the present disclosure, or other methods that use multiple reference lines. Further, the video decoding device may restrict the available reference lines for blocks that meet certain conditions. The following describes controlling the reference lines, which is (Implementation 3-1) a method of using a prediction mode of a block and a position of the block in the video, and (Implementation 3-2) a method of using the partitioning structure of the block.

### Implementation 3-1: Using the Prediction Mode of the Block and the Position of the Block in the Image

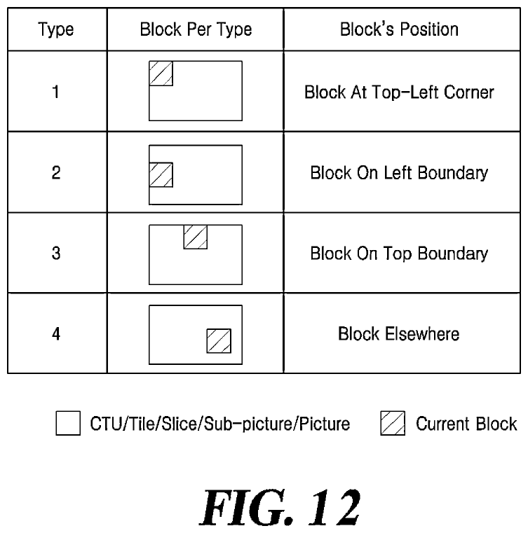

In this implementation, the video decoding device restricts the reference lines according to certain conditions based on the prediction mode of the block, the position of the block in the image, and all available information regarding them. If the current block is located at a boundary of an image, some or all of the reference pixels used for intra prediction may be padded in place of the reconstructed pixels, depending on the type of block illustrated in FIG. 12. With Type 1 for example, where the block is located in the top-left corner of the image and is tangent to both the left and top boundaries of the image, all reference pixels in the current block are generated according to the padding and all have the same pixel value. With Type 2, where the block is adjacent to the left boundary of the image, the reference pixels on the left reference line of the current block are generated according to the padding and all have the same pixel value. Additionally, with Type 3, where the block is adjacent to the top boundary of the image, the reference pixels on the top reference line of the current block are generated according to the padding and all have the same pixel value. In this case, the padding is applied in the same principle to reference lines further away from the block as well as to reference lines adjacent to the block, so that if a block of Type 1 to Type 3 uses multiple reference lines in the left or top reference line direction, depending on the type, all of the multiple reference lines in that direction may have the same pixel value. Since it is rather inefficient to use multiple reference lines in such cases, the video decoding device may control the available reference lines.

In this implementation, if the type of the current block is Type 1 to Type 3, which is located at the boundary of the image, the video decoding device restricts the MRL technique from utilizing multiple reference lines. Namely, the video decoding device uses the reference line indicated by intra_luma_ref_idx 0, which is a single reference line adjacent to the block, exclusively for prediction. This implementation may be configured to apply to seven combinations of Type 1 to Type 3: to Type 1 only, to Type 2 only, to Type 3 only, to Type 1/Type 2, to Type 1/Type 3, to Type 2/Type 3, or to both Type 1 and Type 3. The image may be a picture, sub-picture, slice, tile, CTU, and the like.

In a syntax transmission according to this implementation, if the current block is located at a boundary of the image, the video decoding device does not parse the signal associated with the reference line. For example, if the MRL is applied in Implementation 1-1 (determining a reference line group by signaling, and using one reference line in the reference line group for prediction), and the reference lines are controlled according to this implementation (when to this implementation is applied to both Types 1 to Type 3), the syntax elements according to this implementation are as follows. At least one or more of these syntax elements may be used.

selective_mrl_flag is a flag indicating whether the selective MRL is to be applied, and selective_mrl_flag is parsed when the type of the current block is not one of type 1 to type 3, and may have values of 0 and 1. If this flag is 0, intra_luma_ref_idx 0 is used for prediction, and if this flag is 1, the reference line group is signaled to determine which reference line to use according to this implementation. If selective_mrl_flag is not present, selective_mrl_flag may be inferred to be 0.

ref_group_idx indicates the determined reference line group and may have a value of 0 or more.

ref_group_candidate_idx is a reference line candidate index indicating a reference line to be used within the determined reference line group. ref_group_candidate_idx indicates a selected reference line within the reference line group and may have a value of 0 or more.

The preferred pseudocode according to this implementation may be realized as follows.

```
if (current block is not of one of Type 1 through Type 3)
    Parse selective MRL flag (selective_mrl_flag)
if (selective MRL applied)
  Parse reference line group index (ref_group_idx)
    Parse reference line candidate index (ref_group_candidate_idx)
Parse intra-prediction mode
```

Here, either the intra-prediction mode or the selective MRL flag may be parsed first. The ref_group_candidate_idx is parsed if the reference line is determined by signaling the reference line, and is not parsed if the reference line is inferred.

According to the pseudocode described above, a syntax for transmission is shown in Table 13. In Table 13, the selective MRL flag is parsed first, and then the reference line candidate index is parsed from the determined reference line group.

```
TABLE 13
} else {
  if(sps_selective_mrl_enabled_flag && blockType != type1 &&
      blockType != type2 && blockType != type3)
    selective_mrl_flag
  if( selective_mrl_flag == 1) {
    ref_group_idx
    ref_group_candidates_idx
  }
  if(sps_isp_enabled_flag && selective_mrl_flag==0 &&
        ( cbWidth <= MaxTbSizeY && cbHeight <=
        MaxTbSizeY ) &&
        ( cbWidth * cbHeight > MinTbSizeY * MinTbSizeY ) &&
        !cu act_enabled_flag )
    intra_subpartitions_mode_flag
  if( intra_subpartitions_mode_flag = = 1 )
    intra_subpartitions_split_flag
  if( selective_mrl_flag = = 0 )
    intra_luma_mpm_flag[ x0 ][ y0 ]
  if( intra_luma_mpm_flag[ x0 ][ y0 ] ) {
    if( selective_mrl_flag = = 0)
        intra_luma_not_planar_flag[ x0 ][ y0 ]
    if( intra_luma_not_planar_flag[ x0 ][ y0 ] )
        intra_luma_mpm_idx[ x0 ][ y0 ]
  } else
    intra_luma_mpm_remainder[ x0 ][ y0 ]
}
```

As another example, the video decoding device may further use the intra-prediction mode of the current block as a condition for controlling the reference lines in addition to the location of the block in the image. If the current block is located at a boundary of the image and uses reference pixels that are not reconstructed along the prediction direction, the video decoding device restricts the MRL technique from using multiple reference lines. Namely, the video decoding device uses the reference line indicated by the single reference line adjacent to the block, intra_luma_ref_idx 0, exclusively for prediction.

For example, if the block type is Type 1, the reference line may be controlled in all intra-prediction modes because all reference pixels in the current block are generated according to the padding and all have the same pixel value. If the block type is Type 2, the reference lines may be restricted in prediction modes that use left reference lines because the reference pixels on the left reference line of the current block are generated according to the padding and all have the same pixel value. In this case, the prediction mode using the left reference line includes the prediction mode using only the left reference line (1), HOR_Idx (mode 18) or less) or the mode using both the left and top reference lines (2), less than VER_Idx mode (mode 50) and more than HOR_Idx mode (mode 18). This implementation may be applied when the current block type is Type 2 and has the prediction mode of (1), or this implementation may be applied when the block type is Type 2 and has the prediction modes of 1 and 2.

In addition, if the block type is Type 3, the reference pixels of the top reference line of the current block are generated according to the padding and all have the same pixel value, so the reference lines may be controlled in the prediction mode that uses the top reference line. In this case, the prediction modes that use the top reference line include the mode ((2) that uses both the left and top reference lines or the prediction mode that uses only the top reference line (3), VER_Idx mode (mode 50 or above)). This implementation may be applied when the current block type is Type 3 and has the prediction modes of (2 and 3), or this implementation may be applied when the current block type is Type 3 and has the prediction mode of 3. Further, this implementation may be configured to apply to seven combinations of Type 1 to Type 3: to Type 1 only, to Type 2 only, to Type 3 only, to Type 1/Type 2, to Type 1/Type 3, to Type 2/Type 3, or to both Type 1 and Type 3.

For example, if the current block is of Type 2 and is in prediction mode 2, which uses only the left reference line, the current block does not use multiple reference lines and always uses intra_luma_ref_idx 0.

In a syntax transmission accordingly, if the current block is located at a boundary of the image and is in a prediction mode subjected to this implementation, the video decoding device does not parse the signal associated with the reference line. For example, if the MRL is applied according to Implementation 1-1 (determining a reference line group by signaling, and using one reference line in the reference line group for prediction) and controlling the reference lines according to this implementation (which applies to h Types 1 to Type 3, but is either Type 2 and applies to the prediction mode of (1), or Type 3 and applies to the prediction mode of (3), the syntax elements according to this implementation are as follows. At least one or more of these syntax elements may be used.

selective_mrl_flag is a flag that indicates whether the selective MRL is applied, and may have values of 0 and 1. This flag is parsed if the type of the current block is not one of Types 1 through Type 3, or if each type does not satisfy the prediction mode applied by this Implementation. If this flag is 0, intra_luma_ref_idx 0 is used for prediction, and if this flag is 1, the reference line group is signaled according to this implementation to determine which reference line to use. If selective_mrl_flag is not present, it may be inferred to be 0.

ref_group_idx indicates the determined reference line group and may have a value of 0 or greater.

ref_group_candidate_idx is a reference line candidate index indicating a reference line to be used within the determined reference line group. ref_group_candidate_idx indicates a selected reference line within the reference line group and may have a value of 0 or more.

The preferred pseudocode according to this implementation may be realized as follows.

```
Parse intra-prediction mode
if (current block is not of Type 1, or current block is of Type 2 but not in a
prediction mode of horizontal or less, or current block is of
Type 3 but not in a
prediction ode of vertical or above)
    Parse selective MRL flag (selective_mrl_flag)
if (selective MRL applied)
  Parse reference line group index (ref_group_idx)
    Parse reference line candidate index (ref_group_candidate_idx)
```

Here, the intra-prediction mode is parsed first because the reference line is parsed according to the intra-prediction mode. The ref_group_candidate_idx is parsed if the reference line is determined by signaling the reference line, and is not parsed if the reference line is inferred.

According to the above pseudocode, the syntax for transmission is shown in Table 14. In Table 14, the selective MRL flag is parsed first, and then the reference line candidate index is parsed from the determined reference line group.

```
TABLE 14
  } else {
    intra_luma_mpm_flag[ x0 ][ y0 ]
    if( intra_luma_mpm_flag[ x0 ][ y0 ] ) {
      intra_luma_not_planar_flag[ x0 ][ y0 ]
    if( intra_luma_not_planar_flag[ x0 ][ y0 ] )
      intra_luma_mpm_idx[ x0 ][ y0 ]
    } else
      intra_luma_mpm_remainder[ x0 ][ y0 ]
    if( sps_selective_mrl_enabled_flag && blockType != type1 &&
!(blockType == type2 && IntraPredModeY [ x0 ][
y0 ] ≤ HOR_Idx) &&
!(blockType == type3 && IntraPredModeY [ x0 ][ y0 ] ≥ VER_Idx ))
            selective_mrl_flag
        if( selective_mrl_flag = = 1 ) {
            ref_group_idx
            ref_group_candidate_idx
        }
    if( sps_isp_enabled_flag && selective_mrl_flag = = 0 &&
          ( cbWidth <= MaxTbSizeY && cbHeight <=
          MaxTbSizeY ) &&
          ( cbWidth * cbHeight > MinTbSizeY * MinTbSizeY ) &&
          !cu_act_enabled_flag )
      intra_subpartitions_mode_flag
    if( intra_subpartitions_mode_flag = = 1 )
      intra_subpartitions_split_flag
  }
```

### Implementation 3-2: Utilizing the Partitioning Structure of the Block

In this implementation, the video decoding device controls the available reference lines based on the partitioning structure of the block. Among the N possible reference lines, reference may be restricted for reference lines that are outside of s (s≥1) blocks adjacent to the top and left boundaries of the current block. In this case, s blocks adjacent to the left boundary of the current block, s blocks adjacent to the top boundary, or both may be considered. This implementation is described for convenience where s is 1, but s may be any value of 1 or greater.

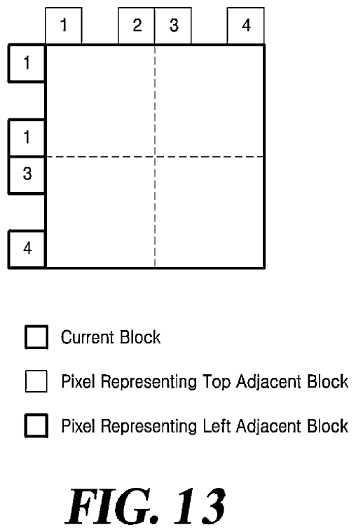

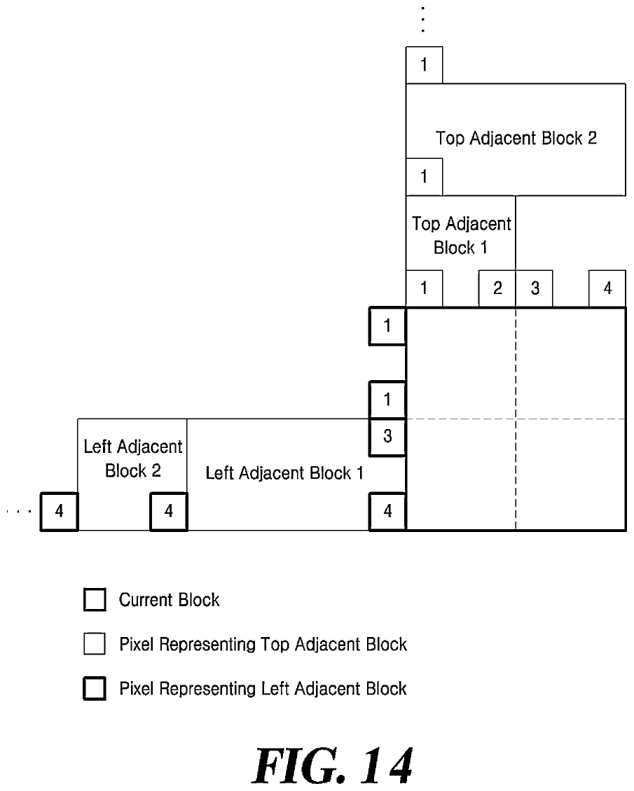

A block adjacent to a left boundary or a top boundary of the current block may include one of the pixels adjacent to each block boundary, in addition to including the pixels at the specific locations illustrated in FIG. 13. In this case, the locations of the pixels defining the left or top adjacent blocks may be different. When s is 2 or more, the i-th block (2≤i≤s) in each of the top and left directions, in order of increasing distance from the current block, is adjacent to the i−1-th block, which is the block immediately preceding the i-th block. In this case, the i-th block in the top direction is defined as a block containing pixels shifted in the −y direction by the sum of the heights of the previous blocks, starting from the pixel positions used to define the first adjacent block. The i-th block in the left direction is defined as a block containing pixels shifted in the −x direction by the sum of the widths of the previous blocks, starting at the pixel position used to define the first adjacent block. For example, pixel position 1 in the example of FIG. 13 may be used to define the top adjacent block, and pixel position 4 in the example of FIG. 13 may be used to define the left-adjacent block. In this case, the top and left multiple adjacent blocks may be defined as shown in the example of FIG. 14.

When only s blocks adjacent to the left boundary of the current block are considered, the video decoding device according to this implementation does not reference any reference lines beyond the left block among the N available reference lines. Namely, the reference line index (intra_luma_ref_idx) value ranges from 0 to the width of the left block (leftBlockW)−1 or less. If only the s blocks adjacent to the top boundary of the current block are considered, the video decoding device according to this implementation does not reference any reference lines outside the top block among the N available reference lines. Namely, the range of reference line index (intra_luma_ref_idx) values from 0 to the height of the top block (aboveBlockH)−1 or less.

Further, when both the left block and the top block are considered, the maximum value of the reference line index (intra_luma_ref_idx) that may be used for prediction may be determined based on the height (aboveBlockH) of the top block and the width (leftBlockW) of the left block. The smaller or larger of the two values may be selected, or the average of the two values may be used. For example, if the smaller of the two values is selected, the reference line index (intra_luma_ref_idx) value may range from 0 to min (leftBlockW−1, aboveBlockH−1) or less.

The following describes methods of controlling the available reference lines in accordance with this Implementation for the benefit of the prior art MRL technology and Implementation 1. In addition, other ways of using multiple reference lines may be implemented similarly to the following.

In one example, when this implementation is applied to a conventional MRL technique, the number of reference lines used for prediction for each block is set differently depending on the partitioning structure of the block. For example, when considering a single block adjacent to the left, a block whose left block has a width of 4 may select one of a total of 4 reference lines (intra_luma_ref_idx 0 to intra_luma_ref_idx 3) to perform a prediction. Further, a block whose left block has a width of 32 may select one of a total of 32 reference lines (intra_luma_ref_idx 0 through intra_luma_ref_idx 31) to perform a prediction.

As another example, when this implementation is applied to a conventional MRL technique, the reference line group to be signaled or inferred for each block is organized differently depending on the partitioning structure of the block. For example, for a single left-adjacent block, it is assumed that the three groups in Table 3 are feasible as the reference line groups used by the block, and assumed that the width of the left block of block A is 4, the width of the left block of block B is 8, and the width of the left block of block C is 16. Further, it is assumed that all three blocks A, B, and C determine their reference line groups by signaling the reference line groups and that the signalized ref_group_idx is 1 in all three blocks. According to Table 3, ‘Group 1’ is {intra_luma_ref_idx 0, intra_luma_ref_idx 4, intra_luma_ref_idx 8}, but according to this implementation, ‘Group 1’ for each of blocks A, B, and C may have a different configuration as shown in Table 15.

TABLE 15

| | Left Block | Reference Line Included in Corresponding |
|---|---|---|
| Block | Width | Reference Line Group |
| A | 4 | {intra_luma_ref_idx 0} |
| B | 8 | {intra_luma_ref_idx 0, intra_luma_ref_idx 4} |
| C | 16 | {intra_luma_ref_idx 0, intra_luma_ref_idx 4, |
| | | intra_luma_ref_idx 8} |

A syntax according to this implementation may be organized the same as a syntax used in an applied MRL method such as a prior art MRL technique, an implementation of the present disclosure, or any other method that uses multiple reference lines. However, if information on adjacent blocks is used as a basis for controlling the reference lines available to the current block, the scope of the syntax elements such as intra_luma_ref_idx and ref_group_candidate_idx representing the reference lines may be restricted. Therefore, when syntax elements representing reference lines are encoded, bits may be allocated differently based on the reference line controlling method applied. For example, if the conventional MRL method is used and unary coding is applied to a case with five referenceable reference lines (intra_luma_ref_idx 0 through 4), the respective reference line indices are represented by 0, 10, 110, 1110, and 1111. If the single left-adjacent block is considered for the reference line controlling and the left block has a width of 4, only 4 reference lines (intra_luma_ref_idx 0 through 3) are available for the current block to use. If unary encoding is applied to this case, the respective reference line indices are represented by 0, 10, 110, and 111, so the controlled reference lines result in a difference in encoding of the reference line indices compared to the uncontrolled case.

### Implementation 4: Adaptively Adjusting Information Based on Reference Line Indices

In this implementation, the video decoding device adaptively adjusts the information according to the reference line index, which is the code table of the reference line indices, and the reference line indicated by the reference line index. Here, the code table represents a table of binary codeword (used interchangeably with ‘codeword’) per reference line index. In this implementation, the video decoding device may (Implementation 4-1) adaptively adjust the code table according to the reference line index, or (Implementation 4-2) adaptively adjust the reference line indicated by the reference line index.

### Implementation 4-1: Adaptively Adjusting the Code Table According to the Reference Line Index

In this implementation, to adaptively adjust the code table according to the reference line index, either (Implementation 4-1-1) changing the mapping between a preset code table and the reference line or (Implementation 4-1-2) adaptively changing the definition of the code table is used.

### Implementation 4-1-1: Changing the Mapping Between a Preset Code Table and a Reference Line

In this implementation, when a codeword for encoding a reference line index is set in a code table, the video decoding device changes the codeword that is mapped to each reference line. For example, let intra_luma_ref_idx 0 through 2 be the three reference line indices used to indicate when three reference lines are available. If the codewords to be encoded for the three reference line indices are 0, 10, and 11, the codeword that maps to each reference line index may be changed, as shown in Table 16.

TABLE 16

| Code Table | Case 0 | Case 1 | Case 2 | . . . |
|---|---|---|---|---|
| 0 | intra_luma_ref_idx 0 | intra_luma_ref_idx 0 | intra_luma_ref_idx 2 | . . . |
| 10 | intra_luma_ref_idx 1 | intra_luma_ref_idx 2 | intra_luma_ref_idx 1 | . . . |
| 11 | intra_luma_ref_idx 2 | intra_luma_ref_idx 1 | intra_luma_ref_idx 0 | . . . |

Here, ‘case’ distinguishes which intra_luma_ref_idx maps to a given codeword, which is equivalent to distinguishing a code table between an intra_luma_ref_idx and a codeword. If this implementation is applied to N reference lines, there may be a total of N! (N factorial) ways to map between reference line indices and codewords.

Meanwhile, the code table corresponding to each case may be represented as shown in Table 17.

TABLE 17

| | |
|---|---|
| codeword | Reference line |

Code table 0

| | |
|---|---|
| 0 | intra_luma_ref_idx 0 |
| 10 | intra_luma_ref_idx 1 |
| 11 | intra_luma_ref_idx 2 |

Code table 1

| | |
|---|---|
| 0 | intra_luma_ref_idx 0 |
| 10 | intra_luma_ref_idx 2 |
| 11 | intra_luma_ref_idx 1 |

Code table 2

| | |
|---|---|
| 0 | intra_luma_ref_idx 2 |
| 10 | intra_luma_ref_idx 1 |
| 11 | intra_luma_ref_idx 0 |

As described above, to change the mapping between the reference line index and the code table, the video decoding device may (Implementation 4-1-1-1) parse and apply the mapping or (Implementation 4-1-1-2) infer the mapping without signaling.

### Implementation 4-1-1-1: Signaling the Mapping

In this implementation, regardless of the parsing of the information on the reference lines (i.e., the syntax) and their order, the video decoding device may determine how to interpret the corresponding bitstream by parsing the mapping code index (‘mapping_code_idx’). In this case, mapping_code_idx represents one of the ‘cases’ in Table 16 (or ‘code tables’ in Table 17) that represent mappings between reference line indices and codewords. For example, with mapping_code_idx 1, the reference line index represented by the codeword is set according to ‘Case 1’ (or ‘Code table 1’). This method changes the way of interpreting the information being signaled, so that for MRLs and other intra-predictions, either the corresponding syntax elements or mapping_code_idx may be parsed first. Further, the mapping_code_idx may be signaled at the CU level or at a higher level such as SPS, PPS, and the like.

As another example, in addition to signaling the code table indicated by intra_luma_ref_idx, a code table determination method may be signaled. In this case, the code table determination method may include any method that may be used to infer the mapping without signaling in Implementation 4-1-1-2. The video decoding device may determine the code table determination method by parsing the mapping method index (hereinafter, “mapping_method_idx”). This method changes the way of interpreting the information being signaled, so that for MRL and other intra predictions, either the corresponding syntax elements or the mapping_method_idx may be parsed first. Further, mapping_method_idx may be signaled at the CU level or at a higher level such as SPS, PPS, and the like.

### Implementation 4-1-1-2: Inferring Mapping without Signaling

In this implementation, the video decoding device infers the mapping between the reference line indices and the code table by using a bitstream interpretation method for inference without signaling. To map shorter and/or entropy coding-favorable codewords to the reference line indices expected to be used in each block, the video decoding device may infer the above described ‘case’ (or ‘Code table’) based on specific information. Referenced may be at least one or more of information related to current block's features of the block width, height, area, and aspect ratio (W, H, log, W, log₂ H, log₂ WH, WH, log₂(W/H), W/H, log₂(H/W), H/W, and the like) and information on the reference line used by an adjacent block of the current block.

These features are further detailed as follows, of which at least one may be referenced. Hereinafter, the distance between a block and a reference line may be an index value of the reference line, the number of pixels between the two, the number of blocks between the two, and the like. Further, both a method of directly indicating the mapping and a method of determining a code table for allowing the inference of the mapping may be utilized as the code table information between intra_luma_ref_idx and the codeword.

First, referenced as current block's features may include the position, prediction mode, reference pixel, any predictors that can be generated, available reference line, the distance between the available reference line and the current block, and the pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

Referenced as features of the adjacent block of the current block may be such features as the position, the pixel value from the block reconstructed, prediction mode, reference line used for prediction, whether MRL is used, code table information between intra_luma_ref_idx that is used and code word, code table information between intra_luma_ref_idx that is optimal for the corresponding block and code word, reference pixel, any predictors that can be generated, available reference line, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, whether MRL is used, code table information between intra_luma_ref_idx that is used and code word, code table information between intra_luma_ref_idx that is optimal for the corresponding block and code word, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and the adjacent block of the collocated block have features that may be referenced such as the position, the pixel value from the block reconstructed, prediction mode, reference line used for prediction, whether MRL is used, code table information between intra_luma_ref_idx that is used and code word, code table information between intra_luma_ref_idx that is optimal for the corresponding block and code word, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

An example of determining a code table, or inferring a code table, for interpreting a bitstream for intra luma_ref_idx based on block's feature to be referenced is as follows.

As an example, for inferring a ‘case’ (or ‘Code table’) by using information on reference lines used by neighboring blocks, if the left-adjacent block predicts with intra luma_ref_idx 2, then ‘Case 2’ (or ‘code table 2’) (in which the fewest bits are assigned to the encoding of intra_luma_ref_idx 2) may be used for encoding the reference line index of the current block. Alternatively, for a case where the ‘Case’ (or ‘code table’) is inferred based on the size of the block, ‘Case 0’ (or ‘code table 0’) may be used if the size of the current block (WH) is 256 or less, and ‘Case 2’ (or ‘code table 2’) may be used if the size of the current block is greater than 256.

As another example, reference is made to current block's prediction mode, the pixel values of the reference lines, and current block's predictor generated from the reference lines. In such cases, in order of decreasing similarity between current block's predictor (pred_{A}) according to a predetermined reference line intra_luma_ref_idx A and current block's predictor (predᵢ) according to the N or N−1 available reference lines, the shorter or entropy coding-favorable codeword may be mapped to the corresponding reference line (intra_luma_ref_idx). In this case, if intra_luma_ref_idx A is one of the N available reference lines, then N−1 reference lines less the the available one are used, or else N reference lines are used. Further, similarity may be calculated by referencing at least one of the following: Sum of Absolute Difference (SAD), Sum of Absolute Transformed Difference (SATD), Mean Squared Error (MSE), and Mean Absolute Error (MAE). Further, if multiple reference lines with the same calculation result are present, the order for the reference lines may be determined by a predetermined method. The predetermined method may take into account, for example, the magnitude of the value of the corresponding reference line index, such that the larger (or smaller) the index value, the shorter or more entropy coding-favorable codeword may be mapped to the corresponding reference line.

Meanwhile, the SAD may be calculated according to Equation 7.

$${SAD}_{i} = SAD ( p r e {d}_{A} , p r e {d}_{i} ) \qquad Equation 7$$

Here, i represents an index value of an available reference line. Further, if intra_luma_ref_idx A is included in the N available reference lines, intra_luma_ref_idx A may be mapped with a codeword determined according to a predetermined method.

As a concrete example, it is assumed that 4 (N=4) reference lines {intra_luma_ref_idx 0, intra_luma_ref_idx 1, intra_luma_ref_idx 2, intra_luma_ref_idx 3} are used in the current block, and the 4 reference lines are represented by four codewords ‘0, 10, 110, 111’, and the predetermined reference line intra_luma_ref_idx A is intra_luma_ref_idx 0. By calculating the SAD between pred₀ and pred₁, pred₂, and pred₃, the mapping between intra_luma_ref_idx and the codeword may be determined according to the result ‘SAD₃>SAD₂>SAD₁’. In this case, since intra_luma_ref_idx A being intra_luma_ref_idx 0 is included in the four available reference lines, intra_luma_ref_idx 0 may be mapped to the shortest or entropy coding-favorable codeword. Thus, intra_luma_ref_idx 0 may be mapped to the codeword ‘O’, intra_luma_ref_idx 3 to ‘10’, intra_luma_ref_idx 2 to ‘110’, and intra_luma_ref_idx 1 to ‘111’. In this case, if multiples of intra_luma_ref_idx are mapped with codewords of the same length, all possible cases may be used to map between a reference line index and a codeword. For example, intra_luma_ref_idx 1 may be mapped with a codeword of ‘110’, and intra_luma_ref_idx 2 may be mapped with a codeword of ‘111’, since the same length codeword is used for both intra_luma_ref_idx 1 and intra_luma_ref_idx 2 in order of priority.

Depending on the implementation, shorter or entropy coding-favorable codewords may be mapped to the corresponding reference lines in an order of increasing value (i.e., in order of decreasing similarity), or in a predetermined order, based on at least one of the above described methods of calculating similarity. The predetermined order may be, for example, an order that alternates between reference lines with smaller and larger similarity values. Additionally, when the values of SAD, SATD, MSE, MAE, and the like are compared, instead of computing the values of SAD, SATD, MSE, MAE, and the like between the predictors, the values of SAD, SATD, MSE, MAE, and the like may be computed between all or some of the pixel values of each reference line. When all pixel values of each reference line are selected, the number of pixels per reference line may vary, so calculations that use averages, such as MAE and MSE, may be preferable.

As another example, a SAD, SATD, MSE, MAE, or the like may be compared between all pixel values of each reference line and a predetermined value, between some pixel values of each reference line and a predetermined value, or between a predictor based on each reference line and a predetermined value.

In accordance with the above description, upon parsing intra_luma_ref_idx, a method of interpreting the signaled bitstream may be determined by a predetermined method.

On the other hand, if a reference line group is used to determine the reference line, the predetermined method may be the method of interpreting the bitstream of ref_group_candidate_idx without changing the reference line (intra_luma_ref_idx) indicated by the reference line candidate index ref_group_candidate_idx. Alternatively, the reference line (intra_luma_ref_idx) indicated by ref_group_candidate_idx may be determined by the predetermined method without changing the method of interpreting the bitstream of ref_group_candidate_idx. This is described as follows.

First, when the reference line group determined according to the predetermined method is used and ref_group_candidate_idx is signaled to indicate one of the candidates, the video decoding device may change the method of interpreting ref_group_candidate_idx to the predetermined method and use the latter. By changing the codeword mapped to ref_group_candidate_idx, the mapping between the code table and the reference line is changed. In this case, ref_group_candidate_idx may indicate the reference line in a corresponding turn within the determined reference line group, or by mapping between ref_group_candidate_idx and intra_luma_ref_idx in a predetermined relationship, the present disclosure may determine the reference line (intra_luma_ref_idx) indicated by ref_group_candidate_idx. Here, the mapping according to the predetermined relationship may be established when there are m reference lines in the reference line group and for indicating the m reference lines as ref_group_candidate_idx 0 to ref_group_candidate_idx m−1 by using an order of increasing value of the reference line index (intra_luma_ref_idx) in the reference line group, decreasing value of the reference line index (intra_luma_ref_idx) in the reference line group, or any other relationship between the indices.

For example, if ref_group_candidate_idx indicates a reference line in a corresponding turn within a reference line group and the reference line group determined by the predetermined method is {intra_luma_ref_idx 0, intra_luma_ref_idx 1, intra_luma_ref_idx 5, intra_luma_ref_idx 3}, then intra_luma_ref_idx indicated by ref_group_candidate_idx is as shown in Table 18.

TABLE 18

| ref_group_candidate_idx | Reference line |
|---|---|
| 0 | intra_luma_ref_idx 0 |
| 1 | intra_luma_ref_idx 1 |
| 2 | intra_luma_ref_idx 5 |
| 3 | intra_luma_ref_idx 3 |

In this case, when coding the four of ref_group_candidate_idx in a unary manner, four codewords 0, 10, 110, 111 are used, and various code tables may be used for mapping between ref_group_candidate_idx and a codeword, as shown in Table 19.

TABLE 19

| | |
|---|---|
| codeword | ref_group_candidate_idx |

Code table 0

| | |
|---|---|
| 0 | 0 |
| 10 | 1 |
| 110 | 2 |
| 111 | 3 |

Code table 1

| | |
|---|---|
| 0 | 0 |
| 10 | 3 |
| 110 | 2 |
| 111 | 1 |

Code table 2

| | |
|---|---|
| 0 | 1 |
| 10 | 3 |
| 110 | 2 |
| 111 | 0 |

In this case, if ref_group_candidate_idx representing the reference line is parsed as 10 and ‘code table 0’ is selected according to the predetermined method, ref_group_candidate_idx may be interpreted as 1 and intra_luma_ref_idx 1 may be used for prediction of the current block. Alternatively, if ‘code table 1’ is selected according to the predetermined method, ref_group_candidate_idx may be interpreted as 3, and intra_luma_ref_idx 3 may be used for prediction of the current block.

In another example, ref_group_candidate_idx indicates a reference line index (intra_luma_ref_idx) within the reference line group in order of increasing value, and the reference line group determined according to the predetermined method is {intra_luma_ref_idx 0, intra_luma_ref_idx 1, intra_luma_ref_idx 5, intra_luma_ref_idx 3}, intra_luma_ref_idx indicated by ref_group_candidate_idx is as shown in Table 20.

TABLE 20

| ref_group_candidate_idx | Reference line |
|---|---|
| 0 | intra_luma_ref_idx 0 |
| 1 | intra_luma_ref_idx 1 |
| 2 | intra_luma_ref_idx 3 |
| 3 | intra_luma_ref_idx 5 |

In addition to this, intra_luma_ref_idx indicated by ref_group_candidate_idx may be determined according to the predetermined method. In the case of coding the four of ref_group_candidate_idx in a unary manner, four codewords 0, 10, 110, and 111 may be used, and various code tables may be used for mapping between ref_group_candidate_idx and the codeword, as shown in Table 19. In this case, if ref_group_candidate_idx indicating a reference line is parsed as 10 and ‘code table 0’ is selected according to the predetermined method, ref_group_candidate_idx may be interpreted as 1 and intra_luma_ref_idx 1 may be used for prediction of the current block. Alternatively, if ‘code table 1’ is selected according to the predetermined method, ref_group_candidate_idx may be interpreted as 3, and intra_luma_ref_idx 5 may be used for the prediction of the current block.

As described above, to change the mapping between the reference line candidate index and the code table, the video decoding device may (Implementation 4-1-1-3) parse and apply the mapping or (Implementation 4-1-1-4) infer the mapping without signaling.

### Implementation 4-1-1-3: Signaling the Mapping

In this implementation, regardless of the parsing of the information on the reference lines (i.e., the syntax) and their order, the video decoding device may parse the mapping_code_idx to determine the method of interpreting the corresponding bitstream. In this case, mapping_code_idx indicates one of the ‘code tables’ in Table 19 that represents a mapping between ref_group_candidate_idx and a codeword. For example, if mapping_code_idx is 1, ref_group_candidate_idx represented by the codeword is set according to ‘Code table 1’. This method changes the method of interpreting the information being signaled, so that for MRLs and other intra-predictions, either the corresponding syntax element or the mapping_code_idx may be parsed first. Additionally, the mapping_code_idx may be signaled at the CU level or at a higher level such as SPS, PPS, and the like.

As another example, in addition to signaling the code table indicated by ref_group_candidate_idx, a code table determination method may be signaled. In this case, the code table determination method may include any method that may be used to infer the mapping without signaling in Implementation 4-1-1-4. The video decoding device may parse the mapping_method_idx to determine the code table determination method. Because this method changes the method of interpreting the information being signaled, either the corresponding syntax elements or the mapping_method_idx may be parsed first for MRL and other intra predictions. Additionally, the mapping_method_idx may be signaled at the CU level or at a higher level such as SPS, PPS, and the like.

### Implementation 4-1-1-4: Inferring Mapping without Signaling

In this implementation, the video decoding device infers the mapping between ref_group_candidate_idx and the code table by using a bitstream interpretation method that infers without signaling. To map shorter and/or entropy coding-favorable codewords to ref_group_candidate_idx expected to be used in each block, the video decoding device may infer the above described ‘Code table’ or code table determination method based on specific information. Referenced may be at least one or more of information related to current block's features of the block width, height, area, and aspect ratio (W, H, log₂ W, log₂ H, log₂ WH, WH, log₂(W/H), W/H, log₂(H/W), H/W, and the like) and information on the reference line used by an adjacent block of the current block.

This may be further described as follows, wherein at least one of these may be referenced. Hereinafter, the distance between a block and a reference line may be an index value of the reference line, the number of pixels between the two, the number of blocks between the two, and the like. Furthermore, the code table information between ref_group_candidate_idx and the codeword may be used both to directly indicate the mapping (the code table in Table 19) and to determine a code table for allowing the inference of the mapping.

First, referenced as current block's features may include the position, prediction mode, reference pixel, any predictors that can be generated, reference line group determined by a predetermined method, the distance between the current block and the available reference line included in the reference line group determined by the predetermined method, and the pixel values of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as features of the adjacent block of the current block may be such features as the position, the pixel value from the block reconstructed, prediction mode, reference line used for prediction, whether MRL is used, used reference line group, code table information between ref_group_candidate_idx that is used and code word, code table information between ref_group_candidate_idx that is optimal for the corresponding block and code word, reference pixel, any predictors that can be generated, available reference line, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, whether MRL is used, used reference line group, code table information between ref_group_candidate_idx that is used and code word, code table information between ref_group_candidate_idx that is optimal for the corresponding block and code word, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and an adjacent block of the collocated block have features that may be referenced such as the position, the pixel value from the block reconstructed, prediction mode, reference line used for prediction, reference line group for use, whether MRL is used, used reference line group, code table information between ref_group_candidate_idx that is used and code word, code table information between ref_group_candidate_idx that is optimal for the corresponding block and code word, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

An example of determining a code table, or inferring a code table, for interpreting a bitstream for ref_group_candidate_idx based on block's feature to be referenced is as follows. The following examples cover determining the reference line (intra_luma_ref_idx) to which ref_group_candidate_idx refers, where the value of ref_group_candidate_idx refers to the reference line of the corresponding order in the reference line group. However, depending on the application, examples may also include mapping ref_group_candidate_idx and intra_luma_ref_idx according to a predetermined relationship such that ref_group_candidate_idx indicates a reference line.

As a first example, when the area (log₂ WH) of the current block is referred to, the mapping method may be inferred by using different code tables depending on the area of the current block, as shown in Table 21.

TABLE 21

| | |
|---|---|
| codeword | ref_group_candidate_idx |

Block Area (log₂WH) < 8

| | |
|---|---|
| 0 | 0 |
| 10 | 1 |
| 11 | 2 |

Block Area (log₂WH) ≥ 8

| | |
|---|---|
| 0 | 2 |
| 10 | 1 |
| 11 | 0 |

If the reference line group of the current block is determined to be {intra_luma_ref_idx 0, intra_luma_ref_idx 1, intra_luma_ref_idx 3}, and the area (log₂ WH) of the current block is 10 and the signaled codeword is 0, then intra_luma_ref_idx may be determined to be 3 because ref_group_candidate_idx is 2.

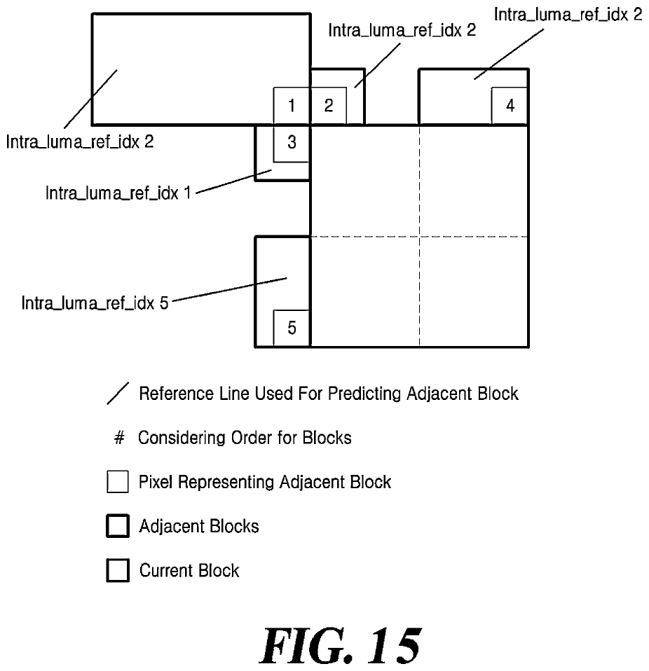

As a second example, for referencing a reference line used by an adjacent block, if the reference line used by the adjacent block exists within the reference line group of the current block, a shorter or entropy coding-favorable codeword may be mapped to ref_group_candidate_idx indicating the reference line. A concrete example is the case where the reference line group of the current block is determined to be {intra_luma_ref_idx 0, intra_luma_ref_idx 1, intra_luma_ref_idx 2}, ref_group_candidate_idx is represented by the three codewords ‘0, 10, 11’, and the adjacent blocks are defined as blocks containing pixels 1 to 5 adjacent to the current block, as shown in the example of FIG. 15. In this case, when blocks 1, 2, and 4 use intra_luma_ref_idx 2 for prediction, block 3 uses intra_luma_ref_idx 1 for prediction, and block 5 uses intra_luma_ref_idx 5 for prediction, intra_luma_ref_idx 2 and intra_luma_ref_idx 1 are included in current block's reference line group, so that ref_group_candidate_idx that indicates the reference lines may be mapped with a shorter or entropy-coding favorable codeword. In this case, the smaller the block number that used the reference line (i.e., the smallest of the block numbers if multiple blocks use the reference line), the shorter or more entropy-coding favorable codeword may be mapped to ref_group_candidate_idx that indicates the reference line. In addition, if a reference line is not used by the adjacent block but the reference line exists in a reference line group, the codeword mapped to ref_group_candidate_idx indicating the reference line may be determined according to a predetermined method.

Based on the example illustrated in FIG. 15 and the above description, it may be determined that a codeword of ‘O’ is mapped to ref_group_candidate_idx 2 indicating intra_luma_ref_idx 2, ‘10’ to ref_group_candidate_idx 1 indicating intra_luma_ref_idx 1, and ‘11’ to ref_group_candidate_idx 0 indicating intra_luma_ref_idx 0. In this case, where multiples of ref_group_candidate_idx are mapped with codewords of the same length, all possible cases may be used for mapping between a reference line candidate index and a codeword. For example, ref_group_candidate_idx 1 may be mapped with a codeword of ‘11’ and ref_group_candidate_idx 0 may be mapped with a codeword of ‘10’ for ref_group_candidate_idx 0 because the same length codeword is used for both ref_group_candidate_idx 1 and ref_group_candidate_idx 0 in order of priority.

A third example describes cases where current block's prediction mode, the pixel values of the reference lines, and current block's predictor generated from the reference lines are referenced. In these cases, a shorter or entropy coding-favorable codeword may be mapped to ref_group_candidate_idx indicating the reference lines in order of decreasing similarity between current block's predictor (pred_{A}) according to a predetermined reference line intra_luma_ref_idx A and current block's predictor (predᵢ) according to the available reference lines in the reference line group. In this case, if intra_luma_ref_idx A exists in a reference line group, the reference lines excluding the same are used, or else, all reference lines in the reference line group may be used. Furthermore, the similarity may be calculated by referring to at least one of SAD, SATD, MSE, and MAE. Further, if there are reference lines with the same calculation result, the order for the reference lines may be determined according to a predetermined method. Here, the predetermined method may take into account, for example, the magnitude of the value of the corresponding reference line index, such that the larger (or smaller) the index value, the shorter or more entropy coding-favorable codewords may be mapped to ref_group_candidate_idx indicating the corresponding reference line.

Meanwhile, the SAD may be calculated according to Equation 8.

$${SAD}_{i} = SAD ( {pred}_{A} , {pred}_{i} ) \qquad Equation 8$$

Here, i indicates the index value of an available reference line in the reference line group. Further, if intra_luma_ref_idx A is included in the reference line group, a codeword determined according to the predetermined method may be mapped to ref_group_candidate_idx indicating intra_luma_ref_idx A.

A concrete example to describe is a case where the reference line group of the current block is determined to be {intra_luma_ref_idx 0, intra_luma_ref_idx 1, intra_luma_ref_idx 2, intra_luma_ref_idx 4}, ref_group_candidate_idx is represented by four codewords ‘0, 10, 110, 111’, and the predetermined reference line intra_luma_ref_idx A is intra_luma_ref_idx 0. By calculating the SAD between pred₀ and pred₁, pred₂, and pred₃, the mapping between ref_group_candidate_idx and the codeword may be determined according to the result ‘SAD₄>SAD₂>SAD₁’. In this case, since intra_luma_ref_idx A being intra_luma_ref_idx 0 is included in the reference line group, ref_group_candidate_idx indicating intra_luma_ref_idx 0 may be mapped to the shortest or entropy coding-favorable codeword. Thus, ref_group_candidate_idx 0 may be mapped to the codeword ‘0’, ref_group_candidate_idx 3 indicating intra_luma_ref_idx 4 may be mapped to the codeword ‘10’, ref_group_candidate_idx 2 indicating intra_luma_ref_idx 2 may be mapped to the codeword ‘110’, and ref_group_candidate_idx 1 indicating intra_luma_ref_idx 1 may be mapped to the codeword ‘111’. In this case, if multiples of ref_group_candidate_idx are mapped with codewords of the same length, all possible cases may be used to map between a reference line candidate index and a codeword. For example, ref_group_candidate_idx 1 and ref_group_candidate_idx 2 use the same length codeword in order of priority, so a codeword of ‘110’ might be mapped to ref_group_candidate_idx 1 and ‘111’ to ref_group_candidate_idx 2.

Depending on the implementation, shorter or entropy coding-favorable codewords may be mapped to the corresponding reference lines in an order of increasing value (i.e., in order of decreasing similarity), or in a predetermined order, based on at least one of the aforementioned methods of calculating similarity. The predetermined order may be, for example, an order that alternates between reference lines with smaller and larger similarity values. Additionally, when the values of SAD, SATD, MSE, MAE, and the like are compared, instead of computing the values of SAD, SATD, MSE, MAE, and the like between the predictors, the values of SAD, SATD, MSE, MAE, and the like may be computed between all or some of the pixel values of each reference line. When all pixel values of each reference line are selected, the number of pixels per reference line may vary, so calculations that use averages, such as MAE and MSE, may be preferable.

Depending on the implementation, the SAD, SATD, MSE, MAE, and the like may be compared between all pixel values of each reference line and a predetermined value, between some pixel values of each reference line and a predetermined value, or between a predictor based on each reference line and a predetermined value.

A fourth example describes referencing code table information between the optimal ref_group_candidate_idx for a previously reconstructed block and codeword. In this case, the mapping between ref_group_candidate_idx and codeword in the current block may be determined according to the same code table as the referenced information and according to the code table determination method. The optimal code table information between ref_group_candidate_idx for the previously reconstructed block and codeword may be determined as follows. Since a reconstruction result exists for the previously reconstructed block, predictors may be generated by using the reconstructed block and the reference lines in the reference line group of the reconstructed block. Then, the shorter or entropy coding-favorable codewords are mapped to ref_group_candidate_idx indicating the reference lines in the order of the reference lines that produce the predictors that most closely resemble the reconstructed values by comparing the reconstructed block with the predictors by SAD, SATD, MSE, MAE, and the like method. Furthermore, any code table information that can produce the same results as these mapping results may be used as the optimal code table information.

Next, when the reference line group determined according to the predetermined method is used for determining the reference line and when ref_group_candidate_idx is signaled to indicate one of the candidates, the video decoding device may determine the reference line (intra_luma_ref_idx) indicated by ref_group_candidate_idx according to the predetermined mapping method. When the codeword mapped to ref_group_candidate_idx is determined, the video decoding device may change the codeword mapped to the reference line by using one type of code table and by changing the reference line (intra_luma_ref_idx) indicated by ref_group_candidate_idx. The following describes an example of using a code table that represents ref_group_candidate_idx as a codeword coded in a unary manner, as shown in Table 22. However, any other available code tables may be used to represent the mapping between ref_group_candidate_idx and codewords.

TABLE 22

| codeword | ref_group_candidate_idx |
|---|---|
| 0 | 0 |
| 10 | 1 |
| 110 | 2 |
| 111 | 3 |

For example, if the reference line group determined according to the predetermined method is {intra_luma_ref_idx 0, intra_luma_ref_idx1, intra_luma_ref_idx 5, intra_luma_ref_idx 3}, ref_group_candidate_idx may be used to indicate one of reference line candidates, and ref_group_candidate_idx may be determined by interpreting the signaled bitstream as shown in Table 22. In this case, various cases may be illustrated in Table 23 as mapping methods for determining the reference line (intra_luma_ref_idx) indicated by ref_group_candidate_idx.

TABLE 23

| | |
|---|---|
| ref_group_candidate_idx | Reference line |

Case 0

| | |
|---|---|
| 0 | intra_luma_ref_idx 0 |
| 10 | intra_luma_ref_idx 1 |
| 110 | intra_luma_ref_idx 3 |
| 111 | intra_luma_ref_idx 5 |

Case 1

| | |
|---|---|
| 0 | intra_luma_ref_idx 1 |
| 10 | intra_luma_ref_idx 0 |
| 110 | intra_luma_ref_idx 5 |
| 111 | intra_luma_ref_idx 3 |

Case 2

| | |
|---|---|
| 0 | intra_luma_ref_idx 0 |
| 10 | intra_luma_ref_idx 5 |
| 110 | intra_luma_ref_idx 3 |
| 111 | intra_luma_ref_idx 1 |

In this case, if ref_group_candidate_idx representing the reference line is parsed as 10, and intra_luma_ref_idx according to ref_group_candidate_idx is determined based on ‘Case 2’, then ref_group_candidate_idx may be 1 and the reference line may be determined as intra_luma_ref_idx 5 according to ‘Case 2’.

Further, if the mapping between ref_group_candidate_idx and the reference line (intra_luma_ref_idx) is such that ref_group_candidate_idx indicates the reference line in a corresponding order within the reference line group, the mapping may be implemented by changing the order of reference lines within the reference line group. For example, if the reference lines indicated by ref_group_candidate_idx are determined according to ‘Case 2’, as in the example above, the reference line group may be represented as {intra_luma_ref_idx 0, intra_luma_ref_idx 5, intra_luma_ref_idx 3, intra_luma_ref_idx 1} by changing the order of the reference lines. The mapping may be performed identically to ‘Case 2’, as ref_group_candidate_idx indicates the reference lines in that order within the reference line group.

On the other hand, the video decoding device may (Implementation 4-1-1-5) parse and apply the mapping between ref_group_candidate_idx and the reference line (intra_luma_ref_idx) as described above, or (Implementation 4-1-1-6) infer the mapping without signaling. In this case, as described above, if the mapping between ref_group_candidate_idx and reference line (intra_luma_ref_idx) is such that ref_group_candidate_idx indicates the reference lines in that order within the reference line group, the mapping may be implemented by changing the order of the reference lines within the reference line group. Thus, all of the signaling and inferencing methods below that determine the mapping between ref_group_candidate_idx and intra_luma_ref_idx may also be implemented by changing the order of the reference lines in the reference line group.

### Implementation 4-1-1-5: Signaling the Mapping

In this implementation, regardless of the parsing of the information on the reference lines (i.e., the syntax) and their order, the video decoding device may determine the method of determining the reference line (intra_luma_ref_idx) indicated by ref_group_candidate_idx by parsing the mapping line index (hereinafter, ‘mapping_line_idx’). In this case, mapping_line_idx indicates one of the cases in Table 13 that represents the mapping between ref_group_candidate_idx and intra_luma_ref_idx. For example, if mapping_line_idx is 1, the reference line represented by ref_group_candidate_idx is determined according to ‘Case 1’. This method changes the method of interpreting the information being signaled, so that for MRL and other intra-predictions, either the corresponding syntax elements or mapping_line_idx may be parsed first. Further, the mapping_line_idx may be signaled at the CU level or at a higher level such as SPS, PPS, and the like.

As another example, in addition to signaling intra_luma_ref_idx mapped to ref_group_candidate_idx in a tabular manner, the mapping method may be signaled. In this case, the mapping method may include any method that may be used to infer the mapping without signaling in Implementation 4-1-1-6. The video decoding device may determine the mapping method by parsing the mapping_method_idx. Since this method changes the method of interpreting the information being signaled, for the MRL and other intra predictions, any of the corresponding syntax elements and mapping_method_idx may be parsed first. Additionally, mapping_method_idx may be signaled at the CU level or at a higher level such as SPS, PPS, and the like.

### Implementation 4-1-1-6: Inferring Mapping without Signaling

In this implementation, the video decoding device infers the mapping between ref_group_candidate_idx and intra_luma_ref_idx by using the bitstream interpretation method of inferring without signaling. As mentioned above, based on the cases in Table 23, the expected reference line indices to be used in each block may be mapped to ref_group_candidate_idx with shorter or entropy coding-favorable codewords. To use these cases, the video decoding device may infer the mapping determination method or the mapping based on specific information. The specific information may be described in more detail as follows, at least one of which may be referenced. Hereinafter, the distance between the block and the reference line may be an index value of the corresponding reference line, the number of pixels between the two, the number of blocks between the two, and the like. Furthermore, the mapping information between ref_group_candidate_idx and intra_luma_ref_idx may be both a direct indication method of the mapping between the two (as in the case of Table 23) and a determination method of the mapping.

First, referenced as current blocks features may include the position, prediction mode, reference pixel, any predictors that can be generated, reference line group determined by a predetermined method, the distance between the current block and the available reference line included in the reference line group determined by the predetermined method, and pixel values of the available reference line. Additionally referenced may be W, H, log₂ W, log₂ H, log₂ WH, WH, log₂(W/H), W/H, log₂(H/W), H/W, and the like related to width (W), height (H), area, and aspect ratio.

Referenced as features of the adjacent block of the current block may be such features as the position, the pixel value from the block reconstructed, prediction mode, reference line used for prediction, whether MRL is used, used reference line group, mapping information between ref_group_candidate_idx that is used and intra_luma_ref_idx, mapping information between ref_group_candidate_idx that is optimal for the corresponding block and intra_luma_ref_idx, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, whether MRL is used, used reference line group, mapping information between ref_group_candidate_idx that is used and intra_luma_ref_idx, mapping information between ref_group_candidate_idx that is optimal for the corresponding block and intra_luma_ref_idx, reference pixel, any predictors that can be generated, distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and the adjacent block of the collocated block have features that may be referenced such as the position, the pixel value from the block reconstructed, prediction mode, reference line used for prediction, whether MRL is used, used reference line group, mapping information between ref_group_candidate_idx that is used and intra_luma_ref_idx, mapping information between ref_group_candidate_idx that is optimal for the corresponding block and intra_luma_ref_idx, reference pixel, any predictors that can be generated, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

Examples of inferring a determination method of mapping between a ref_group_candidate_idx and an intra_luma_ref_idx based on a feature of the referenced block, or inferring the mapping are described below. The following examples describe the use of a code table where the value of ref_group_candidate_idx is a codeword coded in a unary manner to represent the corresponding ref_group_candidate_idx. However, depending on the application, examples using any code table that can represent a mapping between a ref_group_candidate_idx and a codeword are also viable.

As a first example, when the area (log₂ WH) of the current block is referred to, the mapping may be determined differently depending on the area of the current block, as shown in Table 24.

TABLE 24

| | |
|---|---|
| ref_group_candidate_idx | Reference line |

Block Area (log₂WH) < 8

| | |
|---|---|
| 0 | intra_luma_ref_idx 0 |
| 1 | intra_luma_ref_idx 1 |
| 2 | intra_luma_ref_idx 2 |

Block Area (log₂WH) ≥ 8

| | |
|---|---|
| 0 | intra_luma_ref_idx 2 |
| 1 | intra_luma_ref_idx 1 |
| 2 | intra_luma_ref_idx 0 |

If the reference line group of the current block is determined to be {intra_luma_ref_idx 0, intra_luma_ref_idx 1, intra_luma_ref_idx 2} and the area (log₂ WH) of the current block is 10 and ref_group_candidate_idx is 2, then intra_luma_ref_idx may be determined to be 0.

As a second example, for referencing a reference line used by an adjacent block, if the reference line used by the adjacent block exists within the reference line group of the current block, a shorter or entropy coding-favorable codeword may be mapped to ref_group_candidate_idx indicating the reference line. A concrete example is the case where the reference line group of the current block is determined to be {intra_luma_ref_idx 0, intra_luma_ref_idx 1, intra_luma_ref_idx 2} and the adjacent blocks are defined as blocks containing pixels 1 to 5 adjacent to the current block, as shown in the example of FIG. 15. In this case, when blocks 1, 2, and 4 use intra_luma_ref_idx 2 for prediction, block 3 uses intra_luma_ref_idx 1 for prediction, and block 5 uses intra_luma_ref_idx 5 for prediction, intra_luma_ref_idx 2 and intra_luma_ref_idx 1 are included in current block's reference line group, so that ref_group_candidate_idx that indicates the reference lines with a shorter or entropy-coding favorable codeword. In this case, as the block number that used the reference line (i.e., the smallest of the block numbers if multiple blocks use the reference line) gets smaller, the reference block may be mapped to ref_group_candidate_idx represented by the shorter or entropy-coding favorable codeword. In addition, if a reference line is not used by the adjacent block but the reference line exists in a reference line group, ref_group_candidate_idx mapped to the reference line may be determined according to a predetermined method.

Based on the example shown in FIG. 15 and the above description, mapping may be determined such that ref_group_candidate_idx 0 indicates intra_luma_ref_idx 2, ref_group_candidate_idx 1 indicates intra_luma_ref_idx 1, and ref_group_candidate_idx 2 indicates intra_luma_ref_idx 0. In this case, if multiples of ref_group_candidate_idx are mapped with codewords of the same length, all possible cases may be used to determine intra_luma_ref_idx indicated by ref_group_candidate_idx. For example, ref_group_candidate_idx 1 and ref_group_candidate_idx 2 use codewords of the same length in a unary manner, so that ref_group_candidate_idx 1 may indicate intra_luma_ref_idx 0, and ref_group_candidate_idx 0 may indicate intra_luma_ref_idx 1.

A third example describes referencing current block's prediction mode, the pixel values of the reference lines, and current block's predictor generated from the reference lines. In such cases, in order of decreasing similarity between current block's predictor (pred_{A}) according to a predetermined reference line intra_luma_ref_idx A and current block's predictor (predᵢ) according to the available reference lines, the corresponding reference line may be mapped to ref_group_candidate_idx represented by the shorter or entropy coding-favorable codeword. In this case, if intra_luma_ref_idx A exists in the reference line group, the reference lines excluding intra_luma_ref_idx A are used, or else all reference lines in the reference line group may be used. Further, similarity may be calculated by referencing at least one of SAD, SATD, MSE, and MAE. Further, if reference lines with the same calculation result are present, the order for the reference lines may be determined by a predetermined method. The predetermined method may take into account, for example, the magnitude of the value of the corresponding reference line index, such that as the index value gets larger (or smaller), the corresponding reference line may be mapped to a ref_group_candidate_idx represented by the shorter or entropy coding-favorable codeword.

Meanwhile, the SAD may be calculated according to Equation 9.

$${SAD}_{i} = SAD ( {pred}_{A} , {pred}_{i} ) \qquad Equation 9$$

Here, i represents the index value of an available reference line in the reference line group. Further, if intra_luma_ref_idx A is included in the reference line group, intra_luma_ref_idx A may be mapped to a predetermined ref_group_candidate_idx.

A concrete example is described where the reference line group of the current block is determined to be {intra_luma_ref_idx 0, intra_luma_ref_idx 1, intra_luma_ref_idx 2, intra_luma_ref_idx 4}, and the predetermined reference line of intra_luma_ref_idx A is intra_luma_ref_idx 0. By calculating the SAD between pred₀ and pred₁, pred₂, and pred₄, the mapping between ref_group_candidate_idx and intra_luma_ref_idx may be determined according to the result ‘SAD₄>SAD₂>SAD₁’. In this case, since intra_luma_ref_idx A being intra_luma_ref_idx 0 is included in the reference line group, intra_luma_ref_idx 0 may be mapped to ref_group_candidate_idx which is represented by the shortest or entropy coding-favorable codeword. Thus, mapping may be performed so that ref_group_candidate_idx 0 indicates intra_luma_ref_idx 0, ref_group_candidate_idx 1 indicates intra_luma_ref_idx 4, ref_group_candidate_idx 2 indicates intra_luma_ref_idx 2, and ref_group_candidate_idx 3 indicates intra_luma_ref_idx 1. In this case, if multiples of ref_group_candidate_idx are mapped with codewords of the same length, all possible cases may be used to determine which intra_luma_ref_idx is to be indicated by ref_group_candidate_idx. For example, ref_group_candidate_idx 3 and ref_group_candidate_idx 3 use the same length codeword in a unary manner, so ref_group_candidate_idx 2 may indicate intra_luma_ref_idx 1, and ref_group_candidate_idx 3 may indicate intra_luma_ref_idx 2.

Depending on the implementation, by referring to at least one of the above described methods of calculating similarity, the corresponding reference line may be mapped to a ref_group_candidate_idx represented by the shortest or the most entropy coding-favorable codeword, in order of increasing value (i.e., in order of decreasing similarity), or in a predetermined order. The predetermined order may be, for example, an order that alternates between reference lines with smaller and larger similarity values. Additionally, when the values of SAD, SATD, MSE, MAE, and the like are compared, instead of computing the values of SAD, SATD, MSE, MAE, and the like between the predictors, the values of SAD, SATD, MSE, MAE, and the like may be computed between all or some of the pixel values of each reference line. When all pixel values of each reference line are selected, the number of pixels per reference line may vary, so calculations that use averages, such as MAE and MSE, may be preferable.

Depending on the implementation, the SAD, SATD, MSE, MAE, and the like may be compared between all pixel values for each reference line and a predetermined value, between some pixel values for each reference line and a predetermined value, or between a predictor base on each reference line and a predetermined value.

A fourth example is described where reference is made to information on the optimal mapping for a previously reconstructed block between ref_group_candidate_idx and intra_luma_ref_idx. The mapping between ref_group_candidate_idx and intra_luma_ref_idx in the current block may be determined according to the same mapping and mapping determination method as the referenced information. The optimal mapping information for a previously reconstructed block between ref_group_candidate_idx and intra_luma_ref_idx may be determined as shown in the following example. Since reconstruction results exist for the previously reconstructed block, predictors may be generated by using the reconstructed block and the reference lines in the reference line group of the reconstructed block. Then, the reconstructed blocks and predictors are compared by SAD, SATD, MSE, MAE, and the like to ensure that the reference lines that result in the predictors that are most similar to the reconstructed values are mapped earlier to ref_group_candidate_idx, which is represented by a shorter or entropy coding-favorable codeword. Furthermore, any code table information that can produce the same result as this mapping may be used as the optimal code table information.

### Implementation 4-1-2: Adaptively Changing the Definition of the Code Table

In this implementation, the video encoding device adaptively changes the definition of the code table depending on the situation to use multiple code tables for the reference line index. An example case is described where three reference lines are available and three reference line indices are used to indicate the three reference lines which are distinguished by intra_luma_ref_idx 0 through 2. In this case, if the codewords representing the three reference line indices are ‘0, 10, 11’, the video encoding device may select and use one of the code tables exemplified in Table 25. If this implementation applies to N reference lines, the number of available code tables is a total of N! (N factorial). Since this is the process of determining the codeword used to encode intra_luma_ref_idx, it is the inverse of the process of interpreting the bitstream for intra_luma_ref_idx described in Implementation 4-1-1. Therefore, the adaptive changes to the code table described below may also be implemented by applying and adapting the methods described in Implementation 4-1-1.

TABLE 25

| | Code | Code | Code | |
|---|---|---|---|---|
| Reference line index | Table 0 | Table 1 | Table 2 | . . . |
| intra_luma_ref_idx 0 | 0 | 0 | 10 | . . . |
| intra_luma_ref_idx 1 | 10 | 11 | 0 | . . . |
| intra_luma_ref_idx 2 | 11 | 10 | 11 | . . . |

The video decoding device may (Implementation 4-1-2-1) parse and apply adaptive changes in the definition of the code table, as described above, or (Implementation 4-1-2-2) may infer the adaptive changes without signaling.

### Implementation 4-1-2-1: Signaling and Determining Adaptive Changes to the Definition of a Code Table

In this implementation, regardless of the parsing of the information on the reference lines (i.e., the syntax) and their order, the video decoding device may determine the method of interpreting the corresponding bitstream by parsing a code table index (hereinafter ‘code_table_idx’). In this case, the code_table_idx indicates one of the ‘code tables’ in Table 25, which indicate the available code tables. For example, if code_table_idx is 1, the reference line index representing the codeword may be interpreted according to ‘code table 1’. This method changes the method of interpreting the information being signaled, so that for MRL and other intra-predictions, either the corresponding syntax elements or code_table_idx may be parsed first. Additionally, the code_table_idx may be signaled at the CU level or at a higher level such as SPS, PPS, and the like.

### Implementation 4-1-2-2: Inferring Adaptive Changes in the Definition of Code Tables

In this implementation, the video decoding device infers an adaptive change in the definition of the code table by using a bitstream interpretation method for inference without signaling. As described above, based on the code tables in Table 25, reference line indices expected to be used in each block may be allocated shorter or entropy coding-favorable codewords. To use such a code table, the video decoding device may infer the above described code table based on specific information. Referenced may be at least one or more of information related to current block's features of the block width, height, area, and aspect ratio (W, H, log₂ W, log₂ H, log₂ WH, WH, log₂(W/H), W/H, log₂(H/W), H/W, and the like) and information on the reference line used by an adjacent block of the current block.

For example, for inferring a code table based on information on the reference lines used by neighboring blocks, ‘Code table 2’ may be used to encode the reference line index of the current block if the left adjacent block predicts with intra_luma_ref_idx 1. Alternatively, in the case where the code table is inferred based on the size of the block, ‘Code table 0’ may be used if the size (WH) of the current block is 256 or less, and ‘Code table 2’ may be used if the size (WH) of the current block exceeds 256.

According to the above description, a codeword used for encoding intra_luma_ref_idx may be determined as a predetermined codeword.

On the other hand, when the reference line group is used to determine the reference line, the codeword used to encode ref_group_candidate_idx may be determined as a predetermined codeword without changing the reference line (intra_luma_ref_idx) indicated by the reference line candidate index ref_group_candidate_idx. Alternatively, the reference line (intra_luma_ref_idx) indicated by ref_group_candidate_idx may be determined according to the predetermined method without changing the codeword used to encode ref_group_candidate_idx.

In this case, the process of determining the codeword used to encode ref_group_candidate_idx may be the inverse of the process of interpreting the bitstream for ref_group_candidate_idx described in Realization 4-1-1. Thus, adaptive changes to the code table for ref_group_candidate_idx may also be realized by applying and adapting the methods described in Implementation 4-1-1. The determination of the reference line (intra_luma_ref_idx) indicated by ref_group_candidate_idx may also be implemented by applying and adapting the methods described in Implementation 4-1-1.

### Implementation 4-2: Adaptively Adjusting the Reference Line Indicated by the Reference Line Index

In this implementation, the video decoding device adjusts the reference line indicated by the reference line index based on block features, such that different reference lines are used for different blocks even with the same reference line index. Referenced may be at least one or more of information related to current block's features of the block width, height, area, and aspect ratio (W, H, log₂ W, log₂ H, log₂ WH, WH, log₂(W/H), W/H, log₂(H/W), H/W, and the like). The specific information may be further described as follows, at least one of which may be referenced. Hereinafter, the distance between a block and a reference line may be an index value of the corresponding reference line, the number of pixels between the two, the number of blocks between the two, and the like.

First, referenced as current block's features may include the position, prediction mode, reference pixel, any predictors that can be generated, available reference line, the distance between the available reference line and the current block, and pixel values of the available reference line. Additionally referenced may be W, H, log₂ W, log₂ H, log, WH, WH, log₂(W/H), W/H, log₂(H/W), H/W, and the like related to width (W), height (H), area, and aspect ratio.

Referenced as features of the adjacent block of the current block may be such features as the position, the pixel value from the block reconstructed, prediction mode, reference line used for prediction, whether MRL is used, reference pixel, any predictors that can be generated, available reference line, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

Referenced as the features of the earlier reconstructed block than the current block may be such features as the position, the pixel value from the block reconstructed, prediction mode, reference line used for prediction, whether MRL is used, reference pixel, any predictors that can be generated, available reference line, the distance between the available reference line and the current block, and the pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

A collocated block with the current block in another referenceable picture and an adjacent block of the collocated block have features that may be referenced such as the position, the pixel value from the block reconstructed, prediction mode, reference line used for prediction, whether MRL is used, reference pixel, any predictors that can be generated, available reference line, the distance between the available reference line and the current block, and pixel value of the available reference line. Additionally referenced may be W, H, log₂ W, log₂ H, log₂ WH, WH, log₂(W/H), W/H, log₂(H/W), H/W, and the like related to width, height, area, and aspect ratio.

The referencing of the features of the collocated block with the current block in another referenceable picture and the adjacent block of the collocated block may be applicable more preferably or according to embodiments exclusively when the current block uses the intra mode in the inter slice.

For example, when the area (WH) of a block is referred to as a block feature, the reference line indicated by the reference line index may be set according to the area of the block, as shown in Table 26.

TABLE 26

| | W × H < 256 | 256 ≤ W × H |
|---|---|---|
| intra_luma_ref_idx 0 | luma_ref_line₀ | luma_ref_line₀ |
| intra_luma_ref_idx 1 | luma_ref_line₁ | luma_ref_line₄ |
| intra_luma_ref_idx 2 | luma_ref_line₂ | luma_ref_line₈ |

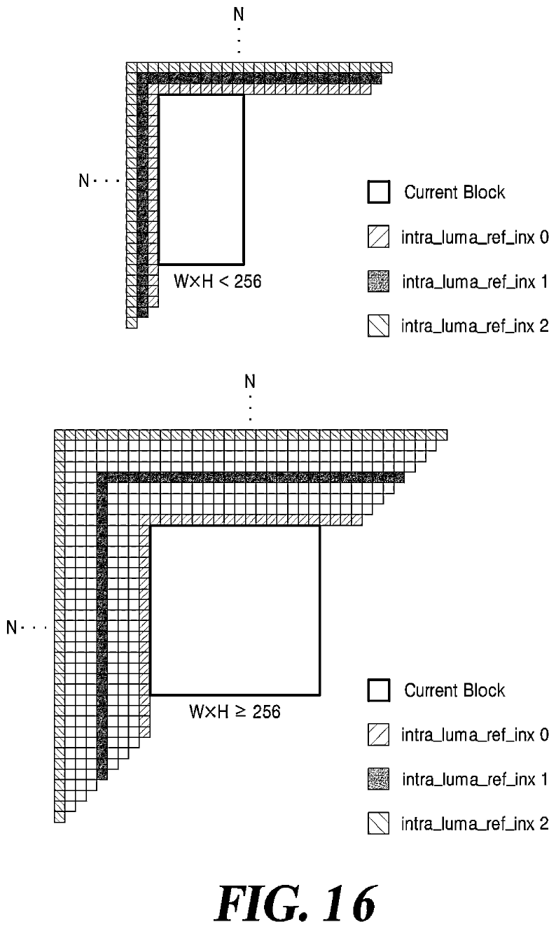

Here, intra_luma_ref_idx is a syntax used to signal the index indicating the reference line, and luma_ref_lineᵢ indicates the reference line that is i pixels away from the current block. Table 26 may be schematized as the illustration of FIG. 16.

### Implementation 5: Signaling of Reference Line Information Considering Block Feature

In this implementation, the video encoding device reflects the block feature in the context model used for entropy coding to signal information on the reference line by taking into account the block feature. Referenced may be at least one or more of information related to current block's features of the block width, height, area, and aspect ratio (W, H, log₂ W, log₂ H, log₂ WH, WH, log₂(W/H), W/H, log₂(H/W), H/W, and the like). The specific information may be further described as follows, at least one of which may be referenced. Hereinafter, the distance between a block and a reference line may be an index value of the corresponding reference line, the number of pixels between the two, the number of blocks between the two, and the like.

First, current block's features described in Implementation 4-2 may be referenced.

The features of the adjacent block of the current block described in Implementation 4-2 may be referenced.

The features of a reconstructed block that is earlier than the current block described in Implementation 4-2 may be referenced.

Referenced also may be the features of the collocated block with the current block in another referenceable picture and the adjacent block of collocated block, which are described in Implementation 4-2.

The referencing of the features of the collocated block with the current block in another referenceable picture and the adjacent block block of collocated block may be applicable more preferably or according to embodiments exclusively when the current block uses the intra mode in the inter slice.

Entropy coding is an encoding method that generates a bitstream based on probabilities, and its context model uses an initial probability value and a probability update rate. If a block feature can identify a probable reference line to be used in the current block, the efficiency of the encoding can be improved by incorporating the block feature into the context model. This implementation may select one of the multiple context models having different initial probability values or probability update rates based on the block feature and then may use the selected context model.

### Implementation 6: Combining the Present Implementations with Existing Technologies

In this implementation, an additional syntax element may be signaled to selectively apply the above described methods of Implementations 1 to 5. In this case, Implementation 3 and Implementation 5 may be applied in conjunction with other implementations or prior art. To this end, the video encoding device may signal selective_mrl_flag to indicate information on how the current block selectively uses the multiple reference lines. For example, as shown in Table 27, if selective_mrl_flag is 0, conventional techniques may be used instead of following the present disclosure, and if selective_mrl_flag is 1, Implementation 2 may be applied.

TABLE 27

| | | |
|---|---|---|
| selective_mrl_flag | 0 | Use existing technology |
| | 1 | Determine reference line according |
| | | to Implementation 2 |

Alternatively, when selective_mrl_flag is 1, any of the methods of Implementations 1 through 5, or combinations thereof, may be used by further signaling selective_mrl_idx, as shown in Table 28.

TABLE 28

| selective_mrl_flag | 0 | Use existing technology | | |
|---|---|---|---|---|
| | 1 | selective_mrl_idx | 0 | Determine reference |
| | | | | line according to |
| | | | | Implementation 1 |
| | | | 1 | Determine reference |
| | | | | line according to |
| | | | | Implementation 2 |
| | | | 2 | Determine reference |
| | | | | line according to |
| | | | | Implementation 3 |
| | | | 3 | Determine reference |
| | | | | line according to |
| | | | | Implementation |
| | | | | 1 & 3 |
| | | | 4 | Determine reference |
| | | | | line in the manner |
| | | | | of Implementation 4 |
| | | | . | . |
| | | | . | . |
| | | | . | . |

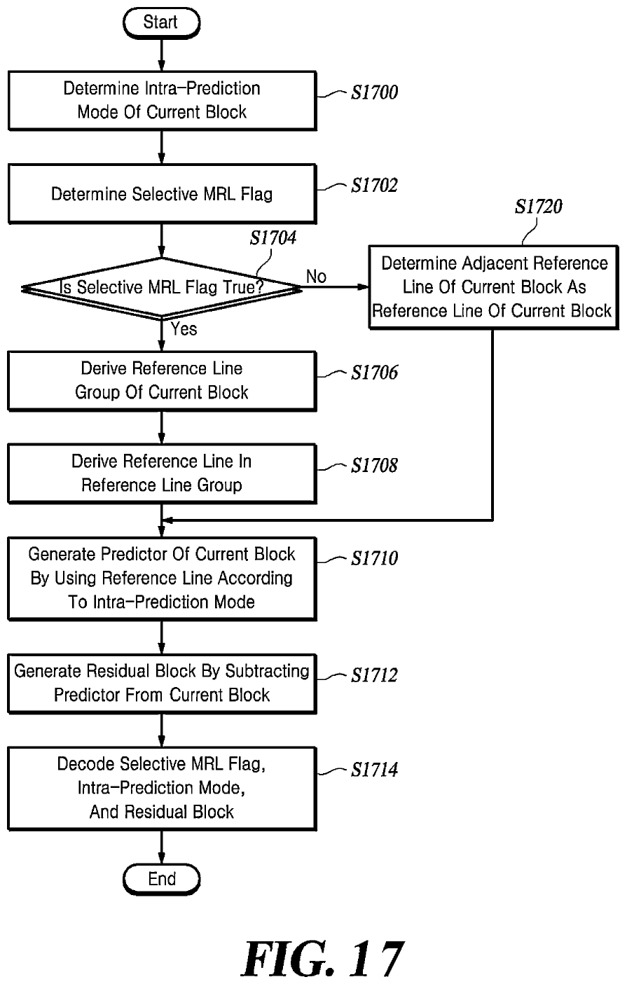

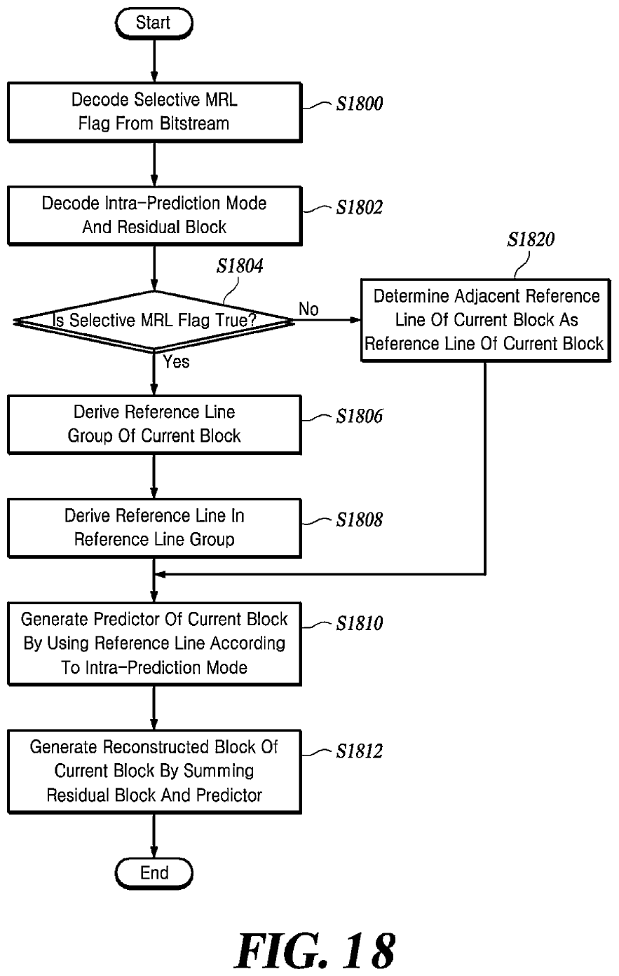

The following describes, with reference to FIGS. 17 and 18, methods of intra-predicting and encoding/decoding the current block by the video encoding device or video decoding device according to Implementation 1. To other implementations, similar descriptions may apply about the methods of intra-predicting the current block and encoding/decoding the current block by the video encoding device or video decoding device.

FIG. 17 is a flowchart of a method performed by a video encoding device for encoding the current block, according to at least one embodiment of the present disclosure.

The video encoding device determines the intra-prediction mode for the current block (S1700).

The video encoding device determines a selective MRL flag (S1702). Here, the selective MRL flag, selective_mrl_flag, indicates whether multiple reference lines are selectively applied for the current block. The video encoding device may determine the selective MRL flag in terms of optimizing coding efficiency. If the selective MRL flag is not determined, the selective MRL flag may be inferred to be false.

The video encoding device checks the selective MRL flag (S1704).

If the selective MRL flag is true (Yes in S1704), the video encoding device performs the following steps.

The video encoding device derives a reference line group of the current block (S1706). Here, the reference line group includes at least one or more reference lines. Further, the reference line group may include reference lines adjacent to the current block.

In one example, the video encoding device may, after determining one reference line group among the plurality of reference line groups, encode a reference line group index indicative of the reference line group, according to Implementation 1-1. In this case, the video encoding device may determine the reference line group in terms of optimizing rate distortion.

As another example, the video encoding device may select one reference line group from the multiple reference line groups based on block features, as in Implementation 1-2-1. Here, the block feature may include all or part of current block's features, features of an adjacent block of the current block, features of the earlier reconstructed block than the current block, and features of the collocated block with the current block in another referenceable picture and the adjacent block of the collocated block.

As yet another example, the video encoding device may use a preset reference line group, such as in Implementation 1-2-2.

The video encoding device derives a reference line within the reference line group (S1708). Here, the reference line in the reference line group is indicated by a reference line candidate index, ref_group_candidate_idx.

The reference line candidate index indicates which reference line is to be used in the reference line group. Alternatively, the reference line candidate index is determined by a mapping between the reference line candidate index and the reference line index, and the reference line index indicates the reference line of the current block.

In one example, the video encoding device may, after determining the reference line candidate index, encode the reference line candidate index according to Implementation 1-1-1, 1-2-1-1, or 1-2-2-1. In this case, the video encoding device may determine the reference line candidate index in terms of optimizing rate distortion.

As another example, the video encoding device may infer a reference line candidate index to use based on a block feature, according to Implementation 1-1-2, 1-2-1-2, or 1-2-2-2, or may use a reference line candidate index preset at a higher level, such as SPS, PPS, or the like. Here, the block feature may include all or part of current block's features, features of an adjacent block of the current block, features of an earlier reconstructed block than the current block, and features of the collocated block with the current block in another referenceable picture and an adjacent block of the collocated block.

On the other hand, when the reference line group includes a single reference line, the video encoding device may encode the reference line candidate index. In this case, the video decoding device may decode the reference line candidate index or infer the reference line candidate index to be zero.

The video encoding device generates a predictor for the current block by using the reference line according to the intra-prediction mode (S1710).

The video encoding device subtracts the predictor from the current block to generate a residual block (S1712).

The video encoding device encodes the selective MRL flag, the intra-prediction mode, and the residual block (S1714).

If the selective MRL flag is false (No in S1704), the video encoding device determines the reference line adjacent to the current block as the reference line of the current block (S1720).

The video encoding device may then perform Steps S1710 through S1714.

FIG. 18 is a flowchart of a method performed by a video decoding device for decoding the current block, according to at least one embodiment of the present disclosure.

The video decoding device decodes a selective MRL flag from the bitstream (S1800). Here, the selective MRL flag, selective_mrl_flag, indicates whether multiple reference lines are selectively applied to the current block.

The video decoding device decodes from the bitstream the intra-prediction mode and residual block of the current block (S1802).

The video decoding device checks the selective MRL flag (S1804).

If the selective MRL flag is true (Yes in S1804), the video decoding device performs the following steps.

The video decoding device derives a reference line group of the current block (S1806). Here, the reference line group includes at least one or more reference lines. Further, the reference line group may include reference lines adjacent to the current block.

In one example, the video decoding device may decode from the bitstream a reference line group index indicating the reference line group and may then determine the reference line group indicated by the reference line group index among multiple reference line groups, according to Implementation 1-1.

As another example, the video decoding device may select one reference line group from the multiple reference line groups based on block features, as in Implementation 1-2-1. Here, the block features may include all or part of current block's features, features of an adjacent block of the current block, features of a block reconstructed earlier than the current block, and features of a collocated block with the current block in another referenceable picture and an adjacent block of the collocated block.

As another example, the video decoding device may use a preset reference line group, such as in Implementation 1-2-2.

The video decoding device derives a reference line within the reference line group (S1808). Here, the reference line in the reference line group is indicated by a reference line candidate index, ref_group_candidate_idx.

The reference line candidate index indicates which reference line is to be used in the reference line group. Alternatively, the reference line candidate index is determined by a mapping between the reference line candidate index and the reference line index which indicates the reference line of the current block.

In one example, the video decoding device may decode from the bitstream the reference line candidate index, according to Implementation 1-1-1, 1-2-1-1, or 1-2-2-1, and then may determine the reference line indicated by the reference line candidate index.

As another example, the video decoding device may, according to Implementation 1-1-2, 1-2-1-2, or 1-2-2-2, infer a reference line candidate index to use based on a block feature or use a reference line preset at a higher level, such as SPS, PPS, or the like. Here, the block feature may include all or part of current block's features, features of an adjacent block of the current block, features of an earlier reconstructed block than the current block, and features of a collocated block with the current block in another referenceable picture and an adjacent block of the collocated block.

Meanwhile, when the reference line group includes a single reference line, the video decoding device may decode the reference line candidate index, or infer the reference line candidate index to be zero.

The video decoding device generates a predictor of the current block by using the reference line according to the intra-prediction mode (S1810).

The video decoding device generates a reconstructed block of the current block by summing the residual block and the predictor (S1812).

If the selective MRL flag is false (No in S1804), the video decoding device determines the reference line adjacent to the current block as the reference line of the current block (S1820).

The video decoding device may then perform Steps S1810 and S1812.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for intra-predicting a current block, the method comprising:
decoding, from a bitstream, an intra-prediction mode of the current block;
deriving a reference line group of the current block, the reference line group comprising at least one reference line;
deriving a reference line within the reference line group, wherein the reference line in the reference line group is indicated by a reference line candidate index; and
generating a predictor of the current block by using the reference line according to the intra-prediction mode.

2. The method of claim 1, further comprising:
decoding, from the bitstream, a selective multiple reference line (MRL) flag that indicates whether multiple reference lines are to be applied selectively for the current block; and
checking the selective MRL flag;
wherein when the selective MRL flag is true, the method further comprises:
deriving the reference line group.

3. The method of claim 2, further comprising, when the selective MRL flag is false:
determining a reference line adjacent to the current block as a reference line of the current block; and
generating a predictor of the current block by using the reference line according to the intra-prediction mode.

4. The method of claim 1, wherein the reference line group comprises:
a reference line adjacent to the current block.

5. The method of claim 1, wherein deriving the reference line group comprises:
decoding, from the bitstream, a reference line group index indicative of the reference line group; and
determining, among a plurality of reference line groups, a reference line group indicated by the reference line group index.

6. The method of claim 1, wherein deriving the reference line group comprises:
selecting the reference line group from a plurality of reference line groups based on block features that include all or part of features of the current block, features of an adjacent block of the current block, features of a block reconstructed earlier than the current block, and features of a collocated block with the current block in another referenceable picture and an adjacent block of the collocated block.

7. The method of claim 1, wherein deriving the reference line within the reference line group comprises:
decoding the reference line candidate index from the bitstream; and
determining a reference line indicated by the reference line candidate index.

8. The method of claim 1, wherein deriving the reference line within the reference line group comprises:
selecting the reference line candidate index based on block features that include all or part of features of the current block, features of an adjacent block of the current block, features of a block reconstructed earlier than the current block, and features of a collocated block with the current block in another referenceable picture and an adjacent block of the collocated block.

9. The method of claim 1, wherein the reference line candidate index indicates which reference line is to be used within the reference line group.

10. The method of claim 1, wherein the reference line candidate index is determined according to a mapping between the reference line candidate index and a reference line index that indicates a reference line of the current block.

11. The method of claim 1, further comprising, when the reference line group comprises one reference line:
decoding the reference line candidate index or inferring the reference line candidate index to be zero.

12. A method performed by a video encoding device for intra-predicting a current block, the method comprising:
determining an intra-prediction mode of the current block;
deriving a reference line group of the current block, wherein the reference line group comprising at least one reference line;
deriving a reference line within the reference line group, wherein the reference line in the reference line group is indicated by a reference line candidate index; and
generating a predictor of the current block by using the reference line according to the intra-prediction mode.

13. The method of claim 12, further comprising:
determining a selective multiple reference line (MRL) flag that indicates whether multiple reference lines are to be applied selectively for the current block; and
checking the selective MRL flag;
wherein when the selective MRL flag is true, the method further comprises:
deriving the reference line group.

14. The method of claim 13, further comprising:
encoding the selective MRL flag.

15. The method of claim 14, further comprising, when the selective MRL flag is false:
determining a reference line adjacent to the current block as a reference line of the current block; and
generating a predictor of the current block by using the reference line according to the intra-prediction mode.

16. A computer-readable recording medium storing a bitstream generated by a video encoding method, the video encoding method comprising:
determining an intra-prediction mode of a current block;
deriving a reference line group of the current block, wherein the reference line group comprising at least one reference line;
deriving a reference line within the reference line group, wherein the reference line in the reference line group is indicated by a reference line candidate index; and
generating a predictor of the current block by using the reference line according to the intra-prediction mode.
